(19) United States
(12) Patent Application Publication
(10) Pub. No.: US 2025/0206923 A1
(43) Pub. Date: Jun. 26, 2025

(54) TIRE

(71) Applicant: SUMITOMO RUBBER INDUSTRIES, LTD., Kobe-shi (JP)

(72) Inventor: Yukari TOMISAKI, Kobe-shi (JP)

(73) Assignee: SUMITOMO RUBBER INDUSTRIES, LTD., Kobe-shi (JP)

(21) Appl. No.: 18/989,765

(22) Filed: Dec. 20, 2024

(30) Foreign Application Priority Data
Dec. 22, 2023 (JP) 2023-217207

(51) Int. Cl. C08L 9/06; B60C 1/00; B60C 11/00; C08K 3/36

(52) U.S. Cl. CPC C08L 9/06; B60C 1/0016; B60C 11/0008; C08K 3/36; B60C 2011/0025; C08K 2201/011; C08L 2205/025; C08L 2205/035; C08L 2205/06; C08L 2207/322

(57) ABSTRACT

Provided is a tire comprising a tread part having a first layer comprising a rubber component and a filler, wherein a maximum load capacity W_{L}, a tire weight G, a land ratio R, 30° C. E*D of the first layer, 30° C. E*_{W} of the first layer, 30° C. tan δ_{D} of the first layer, and 30° C. tan δ_{W} of the first layer satisfy a give relationship.

### CROSS-REFERENCE TO RELATED APPLICATION

This application claims priority to JP Application No. 2023-217207, filed Dec. 22, 2023, the disclosure of which is expressly incorporated herein by reference in its entirety.

### TECHNICAL FIELD

The present invention relates to a tire.

### BACKGROUND OF THE INVENTION

Wet grip performance of a tire has been significantly improved by technical improvement of a rubber composition for tread using silica (for example, JP 2008-285524 A).

### SUMMARY OF THE INVENTION

On the other hand, a change in grip performance, in a case where a road surface change from a dry road surface to a wet road surface or from the wet road surface to the dry road surface, or the like occurs, remains as an important technical problem and there is room for improvement.

Another method of improving wet grip performance is a method of compounding a plasticizer in a rubber composition for tread to soften a rubber. However, softening the tread rubber causes a problem in that fuel efficiency on a dry road surface deteriorates.

It is an object of the present invention to provide a tire that can improve an overall performance of wet grip performance, dry grip performance, and fuel efficiency.

The present invention relates to a tire comprising a tread part having at least one rubber layer, wherein a first layer constituting a tread surface is composed of a rubber composition comprising a rubber component and a filler, wherein the rubber composition comprises 45 parts by mass or more of the filler based on 100 parts by mass of the rubber component, wherein, in a case where W_{L}, in kg, represents a maximum load capacity of the tire, G, in kg, represents a weight of the tire, R represents a land ratio of the tread part on a ground-contacting surface, 30° C. E*_{D} (MPa) represents a complex elastic modulus of the rubber composition at 30° C. when drying, 30° C. E*_{W} (MPa) represents a complex elastic modulus of the rubber composition at 30° C. when wetting, 30° C. tan δ_{D} represents a tan δ at 30° C. of the rubber composition when drying, and 30° C. tan δ_{W} represents a tan δ at 30° C. of the rubber composition when wetting, W_{L}, G, R, 30° C. E*_{D}, 30° C. E*_{W}, 30° C. tan δ_{D}, and 30° C. tan δ_{W} satisfy the following inequalities (1) to (6).

$$R \geq 0.5 \qquad ( 1 )$$

$$G / {W}_{L} \leq 0.025 \qquad ( 2 )$$

$$\vert 30 ° C . {E}_{D}^{⋆} - 30 ° C . {E}^{⋆} w \vert \geq 1.3 \qquad ( 3 )$$

$$\vert 30 ° C . tan {δ}_{D} - 30 ° C . tan δ w \vert \geq 0.03 \qquad ( 4 )$$

$$\vert 30 ° C . {E}_{D}^{⋆} - 30 ° C . {E}^{⋆} w \vert \times R \geq 0.7 \qquad ( 5 )$$

$$\vert 30 ° C . tan {δ}_{D} - 30 ° C . tan δ w \vert / ( G / {W}_{L} ) \geq 1.3 \qquad ( 6 )$$

According to the present invention, provided is a tire that can improve an overall performance of wet grip performance, dry grip performance, and fuel efficiency.

Although it is not intended to be bound by any theory, a reason why the overall performance of wet grip performance, dry grip performance, and fuel efficiency is improved in the tire relating the present embodiment is considered as follows.

In the tire relating to the present invention, (1) by setting the land ratio R to 0.50 or more, drainage performance is secured, which contributes to improvement of a grip force. Moreover, (2) by setting G/W_{L} to 0.025 or less, the weight of the tire is reduced, which contributes to improvement of fuel efficiency.

In addition, by using a rubber composition whose complex elastic modulus and tan δ change reversibly in response to water as the rubber composition constituting the first layer that constitutes the tread surface, wet grip performance and dry grip performance can be synergistically improved. Specifically, (3) it is considered that, by setting a difference between 30° C. E*_{D} and 30° C. E*_{W} to a certain level or more, the tire becomes soft under wet environments while maintaining dry grip and steering stability, which can improve a ground-contacting area when wetting. Moreover, (4) it is considered that, by setting a difference between 30° C. tan δ_{D} and 30° C. tan δ_{W} to a certain value or more, the grip force can be improved while maintaining the usual fuel efficiency.

Furthermore, (5) it is considered that, when a product of 130° C. E*_{D}-30° C. E*_{W}| and R is set to a certain level or more and the difference between 30° C. E*_{D} and 30° C. E*_{W} is small, the ground-contacting area with the road surface can be increased by increasing R, and an influence of a rubber change can be increased. In addition, (6) it is considered that, when a ratio of 130° C. tan δ_{D}−30° C. tan δ_{W}| to G/W_{L} is set to a certain level or more and the difference between 30° C. tan δ_{D} and 30° C. tan δ_{W} is small, the grip force can be improved while maintaining fuel efficiency by decreasing G/W_{L}.

Then, with cooperation of (1) to (6) described above, it is considered that a remarkable effect of improving the overall performance of wet grip performance, dry grip performance, and fuel efficiency is achieved.

### DETAILED DESCRIPTION

The tire that is one embodiment of the present invention is a tire comprising a tread part having at least one rubber layer, wherein a first layer constituting a tread surface is composed of a rubber composition comprising a rubber component and a filler, wherein the rubber composition comprises 45 parts by mass or more of the filler based on 100 parts by mass of the rubber component, wherein, in a case where W_{L}, in kg, represents a maximum load capacity of the tire, G, in kg, represents a weight of the tire, R represents a land ratio of the tread part on a ground-contacting surface, 30° C. E*_{D} (MPa) represents a complex elastic modulus of the rubber composition at 30° C. when drying, 30° C. E*_{W} (MPa) represents a complex elastic modulus of the rubber composition at 30° C. when wetting, 30° C. tan δ_{D} represents a tan δ at 30° C. of the rubber composition when drying, and 30° C. tan δ_{W} represents a tan δ at 30° C. of the rubber composition when wetting, W_{L}, G, R, 30° C. E*_{D}, 30° C. E*_{W}, 30° C. tan δ_{D}, and 30° C. tan δ_{W} satisfy the following inequalities (1) to (6).

$$R \geq 0.5 \qquad ( 1 )$$

$$G / {W}_{L} \leq 0.025 \qquad ( 2 )$$

$$\vert 30 ° C . {E}_{D}^{⋆} - 30 ° C . {E}^{⋆} w \vert \geq 1.3 \qquad ( 3 )$$

$$\vert 30 ° C . tan {δ}_{D} - 30 ° C . tan δ w \vert \geq 0.03 \qquad ( 4 )$$

$$\vert 30 ° C . {E}_{D}^{⋆} - 30 ° C . {E}^{⋆} w \vert \times R \geq 0.7 \qquad ( 5 )$$

$$\vert 30 ° C . tan {δ}_{D} - 30 ° C . tan δ w \vert / ( G / {W}_{L} ) \geq 1.3 \qquad ( 6 )$$

The rubber composition preferably comprises 40 parts by mass or more of silica based on 100 parts by mass of the rubber component from the viewpoint of improving grip performance.

An average primary particle size of the silica is preferably 20 nm or less from the viewpoint of increasing a specific surface area of the silica and increasing an interaction with the rubber component to suppress movement of molecular chains and suppress heat generation.

The rubber composition preferably comprises 5 parts by mass or more of a plasticizer based on 100 parts by mass of the rubber component from the viewpoint of softening the rubber to improve followability to a road surface.

The plasticizer preferably comprises at least one selected from the group consisting of a resin component and a liquid polymer from the viewpoint of improving grip performance.

The rubber component preferably comprises 10% by mass or more of a butadiene rubber from the viewpoint of improving abrasion resistance.

An amount of sulfur in the rubber composition is preferably 0.1% by mass or more from the viewpoint of ensuring reinforcing property.

A glass transition temperature of the rubber composition is preferably −10° C. or lower from the viewpoint of low-temperature embrittlement.

30° C. E*_{D} of the rubber composition is preferably 3.0 MPa or more from the viewpoint of ensuring steering stability.

30° C. tan δ_{D} of the rubber composition is preferably 0.10 or more from the viewpoint of dry grip performance.

### Definition

A “tread part” is a part that forms a ground-contacting surface of a tire, and in a case where the tire comprises a member that forms a tire skeleton from steel or a textile material such as a belt layer, a belt reinforcing layer, a carcass layer, and the like, in a cross section in a tire radial direction, a member on an outer side therefrom in the tire radial direction.

A “belt layer” is a layer provided on an outer side in a tire radial direction with respect to a carcass layer, which corresponds to a plurality of working layers in which internal reinforcing materials are inclined at an angle of about 18° to 30° relative to a tire circumferential direction and overlap in the opposite direction, a circumferential belt layer in which the internal reinforcing materials are oriented at an angle of ±10° relative to the tire circumferential direction, or the like.

A “standardized state” is a state where a tire is rim-assembled on a standardized rim and air under a standardized internal pressure is filled, and no load is applied.

A “dimension of each part of the tire” is a value specified in a standardized condition for one appearing on the outer surface of the tire, unless otherwise specified, while it is a value specified in a condition where, for example, the tire is cut on a plane including a tire rotation axis and the cut tire piece is held to a rim width of a standardized rim for one present inside the tire or on a tire cutting surface.

A “standardized rim” is a rim in a standard system including a standard on which the tire is based, defined by the standard for each tire. For example, the “standardized rim” refers to a standard rim of an applicable size described in “JATMA YEAR BOOK” in JATMA (The Japan Automobile Tyre Manufacturers Association, Inc.), “Measuring Rim” described in “STANDARDS MANUAL” in ETRTO (The European Tyre and Rim Technical Organisation), or “Design Rim” described in “YEAR BOOK” in TRA (The Tire and Rim Association, Inc.), to which references are made in this order, and if there is an applicable size at the time of the reference, the rim conforms to its standard. Besides, in a case of tires that are not defined by the standard, the standardized rim shall refer to one which can be assembled to the tire and whose width is narrowest among rims having the smallest diameter that can maintain an internal pressure (i.e., do not cause air leakage between the rim and the tire).

A “standardized internal pressure” is an air pressure in a standard system including a standard on which the tire is based, defined by the standard for each tire, for example, it refers to a “MAXIMUM AIR PRESSURE” in JATMA, “INFLATION PRESSURE” in ETRTO, or a maximum value described in Table “TIRE LOAD LIMITS AT VARIOUS COLD INFLATION PRESSURES” in TRA, to which references are made in this order as in the case of the standardized rim, and if there is an applicable size at the time of the reference, the standardized internal pressure conforms to its standard. Besides, in a case of tires that are not defined by the standard, the standardized internal pressure shall refer to a standardized internal pressure (250 KPa or more) of another tire size (specified in the standard) for which the standardized rim is described as a standard rim, and when a plurality of standardized internal pressures of 250 KPa or more are described, it shall refer to the minimum value among them.

A “standardized load” is a load in a standard system including a standard on which the tire is based, defined by the standard for each tire, for example, a “MAXIMUM LOAD CAPACITY” in JATMA, a “LOAD CAPACITY” in ETRTO, or a maximum value described in Table “TIRE LOAD LIMITS AT VARIOUS COLD INFLATION PRESSURES” in TRA, to which references are made in this order as in cases of a standardized rim and a standardized internal pressure, and if there is an applicable size at the time of the reference, the load conforms to its standard. Then, in a case of tires that are not defined by the standard, the maximum load capacity W_{L} calculated separately is defined as a standardized load.

The “maximum load capacity W_{L}” is calculated by the following equations. Wherein “V” is a virtual volume, in mm3, of a tire, “Dt” is a tire outer diameter, in mm, in a standardized state, “Ht” is a tire cross-sectional height, in mm, in a tire radial direction on a cross section of the tire in a plane including a tire rotation axis, and “Wt” is a tire cross-sectional width, in mm, in a standardized state. When R represents a rim diameter of the tire, Ht can be calculated by (Dt-R)/2. Wt it is a value obtained by excluding, if any, patterns or characters on the side surface of the tire. Besides, the “maximum load capacity” has the same meaning as the above-described standardized load.

$${W}_{L} = 0.000011 \times V + 175$$

$$V = [ {( Dt / 2 )}^{2} - {( Dt / 2 - H t )}^{2} \} \times π \times Wt$$

A “ground-contacting region” is a tread region obtained from a contour when a tire is pressed against the ground and obtained by mounting the tire on a standardized rim, applying a standardized internal pressure, and leaving the tire to stand at 25° C. for 24 hours, followed by painting a tread surface of the tire with ink, applying a standardized load (the maximum load capacity) on the tire to press the tire vertically against a cardboard (a camber angle at 0°), and transferring the ink. An area of the ground-contacting region refers to a total ground-contacting area. The total ground-contacting area can be calculated as an average value of five areas obtained by performing the above-described transferring operation at a total of five locations by rotating a tire by 720.

An “effective ground-contacting region” is a tread region where a tire touches the ground when the tire is pressed against the ground and obtained by mounting the tire on a standardized rim, applying a standardized internal pressure, and leaving the tire to stand at 25° C. for 24 hours, followed by painting a tread surface of the tire with ink, applying a standardized load (the maximum load capacity) on the tire to press the tire vertically against a cardboard (a camber angle at 0°), and transferring the ink. An area of the effective ground-contacting region refers to an effective ground-contacting area. The effective ground-contacting area can be calculated as an average value of five areas obtained by performing the above-described transferring operation at a total of five locations by rotating a tire by 72°.

A “land ratio R” is calculated from a total ground-contacting area of the ground-contacting region and an effective ground-contacting area of the effective ground-contacting region by the following equation.

(Land ratio)=(effective ground-contacting area/total ground-contacting area)

The term “change reversibly in response to water” means that physical properties of an vulcanized rubber composition change reversibly in response to the presence of water. Besides, for example, when the physical properties change when drying→when wetting→when drying, the physical properties need only to change reversibly, and the physical properties do not necessarily have to be the same when drying in the first and when dying in the last.

A “plasticizer” is a material that imparts plasticity to a rubber component, which is a component extracted from a rubber composition using acetone. The plasticizer includes a plasticizer that is liquid (in a liquid state) at 25° C. and a plasticizer that is solid at 25° C. However, it shall not comprise wax and stearic acid commonly used in the tire industry.

A “content of a plasticizer” also includes an amount of a plasticizer contained in an extended rubber component previously extended with the plasticizer such as oil, a resin component, a liquid rubber component, and the like. The same applies to a content of oil, a content of a resin component, and a content of a liquid rubber, for example, an extending oil is included in the content of oil when an extending component is oil.

### <Measuring Method>

“30° C. E*” is a complex elastic modulus measured using a dynamic viscoelasticity measuring device (e.g., EPLEXOR series manufactured by gabo Systemtechnik GmbH), under a condition of a temperature at 30° C., a frequency of 10 Hz, an initial strain of 5%, a dynamic strain of ±1%, and an extension mode. A sample for measurement of 30° C. E* is a vulcanized rubber composition with 20 mm in length×4 mm in width×1 mm in thickness. When the sample is produced by being cut out from a tire, it is cut out from a tread part of the tire so that a tire circumferential direction becomes a long side and a tire radial direction becomes a thickness direction. A sample for measurement of 30° C. E*_{W} is obtained by immersing the vulcanized rubber test piece in water at 25° C. for 12 hours. Moreover, a sample for measurement of 30° C. E*_{D} is obtained by drying the vulcanized rubber composition after wetting with water under reduced pressure in a condition at 80° C. and with 1 kPa or less until it reaches a constant weight.

“30° C. tan δ” is a loss tangent measured using a dynamic viscoelasticity measuring device (e.g., EPLEXOR series manufactured by gabo Systemtechnik GmbH), under a condition of a temperature at 30° C., a frequency of 10 Hz, an initial strain of 5%, a dynamic strain of ±1%, and an extension mode. Samples for measurement of 30° C. tan δ_{W} and 30° C. tan δ_{D} are prepared in the same manner as for 30° C. E*_{W} and 30° C. E*_{D}.

A “glass transition temperature (Tg) of a rubber composition” is a temperature corresponding to a maximum value (tan δ peak temperature) within a range of −60° C. or more and 40° C. or less in a temperature distribution curve of tan δ obtained by measurement, under a condition of a frequency of 10 Hz, an initial strain of 10%, a dynamic strain of ±0.5%, and a temperature rising rate at 2° C./min, using a dynamic viscoelasticity measuring device (e.g., EPLEXOR series manufactured by gabo Systemtechnik GmbH). Besides, in the measurement in the range of −60 to 40° C., if the tan δ value continues to gradually increase or decrease as the temperature rises, the glass transition temperature of the rubber composition shall be 40° C. or −60° C., respectively. Moreover, in the range of −60° C. or higher and 40° C. or lower, if there are two or more points indicating the maximum value, a point having the lowest temperature shall be a glass transition temperature.

An “amount of sulfur” is an amount of sulfur, in % by mass, measured by an oxygen combustion flask method in accordance with JIS K 6233:2016. A sample for measurement of the amount of sulfur is a vulcanized rubber composition with 20 mm in length×4 mm in width×1 mm in thickness. When the sample is produced by being cut out from a tire, it is cut out from a tread part of the tire so that a tire circumferential direction becomes a long side and a tire radial direction becomes a thickness direction.

A “styrene content” is a value calculated by ¹H-NMR measurement and is applied to, for example, a rubber component having a repeating unit derived from styrene such as an SBR and the like.

A “vinyl content (1,2-bond butadiene unit amount)” is a value calculated by infrared absorption spectrometry according to JIS K 6239-2:2017 and is applied to, for example, a rubber component having a repeating unit derived from butadiene such as an SBR, a BR, and the like.

A “cis content (cis-1,4-bond butadiene unit amount)” is a value calculated by infrared absorption spectrometry according to JIS K 6239-2:2017 and is applied to, for example, a rubber component having a repeating unit derived from butadiene such as a BR and the like.

A “weight-average molecular weight (Mw)” can be calculated in terms of a standard polystyrene based on measurement values obtained by a gel permeation chromatography (GPC) (e.g., GPC-8000 Series manufactured by Tosoh Corporation, detector: differential refractometer, column: TSKgel (Registered trademark) SuperMultiporeHZ-M manufactured by Tosoh Corporation). For example, it is applied to an SBR, a BR, a plasticizer, and the like.

A “nitrogen adsorption specific surface area (N₂SA) of carbon black” is measured according to JIS K 6217-2:2017.

A “nitrogen adsorption specific surface area (N₂SA) of silica” is measured by the BET method according to ASTM D3037-93.

An “average primary particle size” is calculated by an arithmetic mean of particle sizes of 400 particles which are photographed with a transmission or scanning electron microscope. Regarding the particle size, in a case where the particle is in a substantially circular shape, a diameter of the circle is defined as a particle size, in a case where it is in a needle or rod shape, a minor axis is defined as a particle size, and in the other cases, an equivalent circle diameter calculated from an electron microscope image is defined as a particle size. The equivalent circle diameter is calculated as “positive square root of 4×(area of particle)/π”. The average primary particle size is applied to silica, carbon black, etc.

A “softening point of a resin component” is a temperature at which a sphere drops when the softening point specified in JIS K 6220-1:2015 7.7 is measured with a ring and ball softening point measuring device.

A procedure for producing a tire that is one embodiment of the present invention will be described in detail below. However, the following descriptions are illustrative for explaining the present invention, and are not intended to limit the technical scope of the present invention to this description range only.

### [Tire]

In the tire relating to the present embodiment, a ratio (G/W_{L}) of the tire weight G, in kg, to the maximum load capacity W_{L}, in kg, is 0.025 or less, preferably 0.024 or less, more preferably 0.023 or less, further preferably 0.022 or less, particularly preferably 0.021 or less, from the viewpoint of the effects of the present invention. On the other hand, a lower limit of G/W_{L} is not particularly limited from the viewpoint of the effects of the present invention, but can be, for example, 0.012 or more, 0.013 or more, or 0.014 or more. Besides, the tire weight G can be changed by a conventional method, that is, it can be increased by increasing a specific gravity of the tire or by increasing a thickness of each member of the tire, and it can be decreased by decreasing the specific gravity of the tire or by decreasing the thickness of each member of the tire.

The maximum load capacity W_{L}, in kg, is preferably 300 or more, more preferably 400 or more, further preferably 450 or more, particularly preferably 500 or more, from the viewpoint of better exhibiting the effects of the present invention. Moreover, the maximum load capacity W_{L}, in kg, can be, for example, 1300 or less, 1200 or less, 1100 or less, 1000 or less, 900 or less, 800 or less, or 700 or less, from the viewpoint of better exhibiting the effects of the present invention. Besides, the maximum load capacity W_{L} can be increased by increasing the virtual volume V of the space occupied by the tire, and it can be decreased by decreasing the virtual volume V of the space occupied by the tire.

The tire weight G is preferably 8.0 kg or more, more preferably 8.5 kg or more, further preferably 9.0 kg or more, particularly preferably 9.5 kg or more. An upper limit value of the tire weight G is not particularly limited, but is usually 100 kg or less, and can be, for example, 80 kg or less, 60 kg or less, 40 kg, 20 kg, 15 kg or less, or the like.

The land ratio R of the tread part on the ground-contacting surface is 0.50 or more, preferably 0.53 or more, more preferably 0.56 or more, further preferably 0.59 or more, from the viewpoints of securing drainage performance and improving the grip force. Moreover, the land ratio R is preferably 0.85 or less, more preferably 0.80 or less, further preferably 0.75 or less, from the viewpoints of securing drainage performance and suppressing occurrence of a hydroplaning phenomenon. Besides, the land ratio R can be changed by a conventional method, that is, it can be increased by decreasing a groove area of a tread surface and can also be decreased by increasing the groove area of the tread surface.

The tread relating to the present embodiment has at least one rubber layer. The tread relating to the present embodiment may be a tread consisting of a single rubber layer or may be a tread having a first layer whose outer surface constitutes a tread surface and one or more rubber layers present between the first layer and a belt layer (inner rubber layers).

A thickness of the first layer with respect to a thickness of the entire tread part can be, for example, 30% or more, 50% or more, 70% or more, or 90% or more, and the tread may be one consisting of the first layer.

30° C. E*_{D} is preferably 50 MPa or less, more preferably 30 MPa or less, further preferably 15 MPa or less, from the viewpoint of followability to a road surface. On the other hand, 30° C. E*_{D} is preferably 3.0 MPa or more, more preferably 4.0 MPa or more, further preferably 5.0 MPa or more, particularly preferably 6.0 MPa or more, from the viewpoint of ensuring steering stability.

30° C. E*_{W} is preferably 50 MPa or less, more preferably 30 MPa or less, further preferably 15 MPa or less, from the viewpoint of followability to a road surface. On the other hand, 30° C. E*_{W} is preferably 2.0 MPa or more, more preferably 3.0 MPa or more, further preferably 4.0 MPa or more, particularly preferably 5.0 MPa or more, from the viewpoint of ensuring steering stability.

30° C. tan δ_{D} is preferably 0.10 or more, more preferably 0.15 or more, further preferably 0.18 or more, from the viewpoint of dry grip performance. Moreover, 30° C. tan δ_{D} is preferably 0.50 or less, more preferably 0.45 or less, further preferably 0.40 or less, particularly preferably 0.35 or less, from the viewpoint of fuel efficiency.

30° C. tan δ_{W} is preferably 0.10 or more, more preferably 0.15 or more, further preferably 0.18 or more, from the viewpoint of wet grip performance. Moreover, 30° C. tan δ_{W} is preferably 0.50 or less, more preferably 0.45 or less, further preferably 0.40 or less, particularly preferably 0.35 or less, from the viewpoint of fuel efficiency.

Besides, 30° C. E*_{D}, 30° C. E*_{W}, 30° C. tan δ_{D}, and 30° C. tan δ_{W} can be appropriately adjusted depending on types or compounding amounts of a rubber component, a resin component, oil, and the like, which will be described later.

An amount of sulfur in the rubber composition constituting the first layer is preferably 0.1% by mass or more, more preferably 0.3% by mass or more, further preferably 0.5% by mass or more, from the viewpoint of ensuring reinforcing property. On the other hand, an upper limit value of the amount of sulfur in the rubber composition is, but not particularly limited to, usually 2.5% by mass or less. When the amount of sulfur is within the above-described ranges, a cross-linking point between polymers is sufficiently obtained, so that the polymers become less likely to deform. Besides, the amount of sulfur in the rubber composition can be appropriately adjusted depending on compounding amounts of sulfur and vulcanization accelerators which will be described later.

A glass transition temperature (Tg) of the rubber composition constituting the first layer is preferably −100° C. or higher, more preferably −80° C. or higher, further preferably −60° C. or higher, particularly preferably −50° C. or higher, from the viewpoint of the effects of the present invention. Moreover, it is preferably 0° C. or lower, more preferably −10° C. or lower, further preferably −15° C. or lower, from the viewpoint of ensuring low-temperature embrittlement. Besides, the Tg of the rubber composition can be appropriately adjusted depending on types or compounding amounts of a rubber component, a filler, a plasticizer, and the like, which will be described later.

The rubber composition constituting the first layer relating to the present embodiment is characterized in that it satisfies the following inequalities (3) and (4).

$$\vert 30 ° C . {E}_{D}^{⋆} - 30 ° C . {E}^{⋆} w \vert \geq 1.3 \qquad ( 3 )$$

$$\vert 30 ° C . tan {δ}_{D} - 30 ° C . tan δ w \vert \geq 0.03 \qquad ( 4 )$$

|30° C. E*_{D}−30° C. E*_{W}| is preferably 1.4 or more, more preferably 1.5 or more. When 130° C. E*_{D}−30° C. E*_{W}| is within the above-described ranges, it is considered that the ground-contacting area of the tread part can be expected to be increased due to softening by water. On the other hand, an upper limit value of 130° C. E*_{D}−30° C. E*_{W}| is, but not particularly limited to, usually 10 or less, preferably 7.0 or less, more preferably 4.0 or less, further preferably 2.0 or less.

|30° C. tan δ_{D}−30° C. tan δ_{W}| is preferably 0.04 or more, more preferably 0.05 or more. When 130° C. tan δ_{D}−30° C. tan δ_{W}| is within the above-described ranges, it is considered that improvement of grip performance can be expected. On the other hand, an upper limit value of 130° C. tan δ_{D}−30° C. tan δ_{W}| is, but not particularly limited to, usually 0.20 or less, preferably 0.15 or less, more preferably 0.10 or less.

The tire relating to the present embodiment is characterized in that it satisfies the following inequalities (5) and (6).

$$\vert 30 ° C . {E}_{D}^{⋆} - 30 ° C . {E}^{⋆} w \vert \times R \geq 0.7 \qquad ( 5 )$$

$$\vert 30 ° C . tan {δ}_{D} - 30 ° C . tan δ w \vert / ( G / {W}_{L} ) \geq 1.3 \qquad ( 6 )$$

|30° C. E*_{D}−30° C. E*_{W}|×R is more preferably 0.75 or more, further preferably 0.80 or more. When 130° C. E*_{D}−30° C. E*_{W}|×R is within the above-described ranges, it is considered that an optimal synergistic effect of change in rubber physical property and a tire structure can be produced. On the other hand, an upper limit value of 130° C. E*_{D}−30° C. E*_{W}|×R is, but not particularly limited to, usually 1.50 or less, preferably 1.30 or less.

|30° C. tan δ_{D}−30° C. tan δ_{W}|/(G/W_{L}) is preferably 1.4 or more, more preferably 1.6 or more, further preferably 1.8 or more, further preferably 2.0 or more, particularly preferably 2.1 or more. When 130° C. tan δ_{D}−30° C. tan δ_{W}|/(G/W_{L}) is within the above-described ranges, it is considered that both grip performance and fuel efficiency can be expected to be achieved. On the other hand, an upper limit value of 130° C. tan δ_{D}−30° C. tan δ_{W}|/(G/W_{L}) is, but not particularly limited to, usually 5.0 or less, preferably 4.0 or less, more preferably 3.5 or less.

### [Rubber Composition]

In the tire relating to the present embodiment, the above-mentioned configuration of the tire and the tread cooperates with the above-described physical properties of the rubber composition constituting the tread part, so that the overall performance of wet grip performance, dry grip performance, and fuel efficiency can be improved more effectively. The rubber composition constituting the first layer will be described below.

In the present embodiment, in order to reversibly change the complex elastic modulus and the tan δ of the rubber composition using water, it is useful to form some of crosslinks formed by the rubber composition through bonds due to electrostatic interactions such as ionic bonds and the like. With the rubber composition comprising bonds due to electrostatic interactions, the bonds can be reversibly decoupled when water is absorbed into the rubber composition. Therefore, the complex elastic modulus of the rubber composition can be reduced when wetting with water, and the tan δ is increased due to improved hysteresis loss caused by dissociation of bond points. Moreover, since ionic bonds are the strongest of all non-covalent bonds, they can maintain their bonding powers when drying. Besides, in order to form bonds due to electrostatic interactions in the rubber composition, a rubber component, a resin component, silica, a silane coupling agent, and the like, which will be described later, can be modified with a hydrophilic functional group (e.g., a functional group comprising at least one element selected from the group consisting of nitrogen, oxygen, silicon, and sulfur; preferably, at least one selected from the group consisting of a carboxyl group, an amino group, and a hydroxyl group).

Of bonds due to electrostatic interactions, ionic bonds can be introduced into a cross-linked structure of the rubber composition. Such materials are herein referred to as “ionically bonded materials”. Examples of the ionically bonded materials include, for example, an ionically bonded modified rubber, an ionically bonded modified silica, an ionically bonded modified silane coupling agent, an ionically bonded modified plasticizer, and the like, that have been modified so that they can form ionic bonds. Moreover, examples of the ionically bonded modified plasticizer include an ionically bonded modified resin, an ionically bonded modified liquid polymer, and the like. Specific examples of these ionically bonded materials will be described in the sections for rubber components, silica, silane coupling agents, and plasticizers, respectively.

The rubber composition constituting the tread part of the tire relating to the present embodiment (hereinafter referred to as the rubber composition relating to the present embodiment) comprises a rubber component and a filler and can be produced using raw materials described below. The rubber composition relating to the present embodiment will be described below.

### <Rubber Component>

In the rubber composition relating to the present embodiment, a diene-based rubber is appropriately used as a rubber component. Examples of the diene-based rubber include, for example, an isoprene-based rubber, a butadiene rubber (BR), a styrene-butadiene rubber (SBR), a styrene-isoprene rubber (SIR), a styrene-isoprene-butadiene rubber (SIBR), a chloroprene rubber (CR), an acrylonitrile-butadiene rubber (NBR), and the like. Moreover, these diene-based rubbers may be modified rubbers treated with modifying groups capable of interacting with fillers such as carbon black, silica, and the like, or may be hydrogenated rubbers obtained by hydrogenating a part of an unsaturated bond. Among the modified rubbers, a modified rubber into which the above-described hydrophilic functional group has been introduced can be appropriately used as an ionically bonded modified rubber. As the diene-based rubber, an extended rubber which has been previously extended with a plasticizer which will be mentioned later may be used. The diene-based rubber may be used alone, or two or more thereof may be used in combination.

A content of a diene-based rubber in the rubber component is preferably 70% by mass or more, more preferably 80% by mass or more, further preferably 90% by mass or more, particularly preferably 95% by mass or more. Moreover, the rubber component may be one consisting of a diene-based rubber.

At least one selected from the group consisting of an isoprene-based rubber, a styrene-butadiene rubber (SBR), and a butadiene rubber (BR) is appropriately used as the diene-based rubber. The rubber component preferably comprises an SBR, more preferably comprises an SBR and an isoprene-based rubber and/or a BR, further preferably comprises an isoprene-based rubber, a BR, and an SBR, and may be a rubber component consisting of an isoprene-based rubber, an SBR, and a BR.

### (Isoprene-Based Rubber)

The isoprene-based rubber is not particularly limited, examples of which include, for example, a natural rubber (NR), an isoprene rubber (IR), a modified natural rubber, and the like. Examples of the NR include, for example, SIR20, RSS #3, TSR20, and the like. Examples of the IR include, for example, IR2200 and the like. Examples of the modified natural rubber include, for example, an epoxidized natural rubber (ENR), a hydrogenated natural rubber (HNR), a deproteinized natural rubber (DPNR), an ultra pure natural rubber, a grafted natural rubber, and the like. These isoprene-based rubbers may be used alone, or two or more thereof may be used in combination.

A content of an isoprene-based rubber in the rubber component is preferably 50% by mass or less, more preferably 40% by mass or less, further preferably 30% by mass or less, particularly preferably 20% by mass or less, from the viewpoint of the effects of the present invention. Moreover, a lower limit value of the content can be, but not particularly limited to, for example, 1% by mass or more, 3% by mass or more, 5% by mass or more, 7% by mass or more, or 10% by mass or more.

### (SBR)

The SBR is not particularly limited, examples of which include, for example, an unmodified solution-polymerized SBR (S-SBR) and an emulsion-polymerized SBR (E-SBR), modified SBRs (a modified S-SBR, a modified E-SBR) thereof, and the like. Examples of the modified SBR include an SBR modified at its terminal and/or main chain, a modified SBR coupled with tin, a silicon compound, etc. (a modified SBR of condensate or having a branched structure, etc.), and the like. Among them, an S-SBR and a modified SBR are preferable. Furthermore, hydrogenated ones of these SBRs (hydrogenated SBRs) and the like can also be used. These SBRs may be used alone, or two or more thereof may be used in combination.

Among modified SBRs, an SBR modified at its terminal and/or main chain with a functional group comprising at least one element selected from the group consisting of nitrogen, oxygen, silicon, and sulfur can be appropriately used as an ionically bonded modified SBR. Examples of the above-described functional group include, for example, an amino group (preferably an amino group in which a hydrogen atom of the amino group is substituted with an alkyl group having 1 to 6 carbon atoms), an amide group, a silyl group, an alkoxysilyl group (preferably an alkoxysilyl group having 1 to 6 carbon atoms), an isocyanate group, an imino group, an imidazole group, an urea group, an ether group, a carbonyl group, an oxycarbonyl group, a mercapto group, a sulfide group, a disulfide group, a sulfonyl group, a sulfinyl group, a thiocarbonyl group, an ammonium group, an imide group, a hydrazo group, an azo group, a diazo group, a carboxyl group, a nitrile group, a pyridyl group, an alkoxy group (preferably an alkoxy group having 1 to 6 carbon atoms), a hydroxyl group, an oxy group, an epoxy group, and the like. Among them, one or more functional groups selected from the group consisting of an amino group, a carboxyl group, and an alkoxysilyl group are preferable. Besides, these functional groups may have a substituent. Examples of the substituent include, for example, functional groups such as an amino group, an amide group, an alkoxysilyl group, a carboxyl group, a hydroxyl group, and the like. Examples of the modified SBR can include hydrogenated ones, epoxidized ones, tin-modified ones, and the like.

As SBRs relating to the present embodiment, an extended SBR can be used, and a non-extended SBR can also be used. An extending amount of the extended SBR, i.e., a content of an extending plasticizer contained in the SBR when used is preferably 10 to 50 parts by mass based on 100 parts by mass of a rubber solid content of the SBR.

The SBRs listed above may be used alone, or two or more thereof may be used in combination. As the SBRs listed above, for example, those commercially available from Sumitomo Chemical Co., Ltd., JSR Corporation, Asahi Kasei Corporation, Zeon Corporation, ZS Elastomer Co., Ltd., etc. can be used.

A styrene content of an SBR is preferably 40% by mass or less, more preferably 37% by mass or less, further preferably 34% by mass or less, particularly preferably 30% by mass or less. Moreover, the styrene content of the SBR is preferably 5% by mass or more, more preferably 7% by mass or more, further preferably 10% by mass or more, particularly preferably 12% by mass or more. Besides, the styrene content of the SBR is measured by the above-described measuring method.

A vinyl content of an SBR is preferably 5 mol % or more, more preferably 10 mol % or more, further preferably 15 mol % or more, from the viewpoints of ensuring reactivity with silica and abrasion resistance. Moreover, the vinyl content of the SBR is preferably 65 mol % or less, more preferably 60 mol % or less, from the viewpoints of elongation at break and abrasion resistance. Besides, in the present specification, the vinyl content of the SBR is measured by the above-described measuring method.

A weight-average molecular weight (Mw) of an SBR is preferably 100,000 or more, more preferably 200,000 or more, further preferably 300,000 or more, from the viewpoint of the effects of the present invention. Moreover, it is preferably 2,000,000 or less, more preferably 1,800,000 or less, further preferably 1,500,000 or less, from the viewpoint of cross-linking uniformity. Besides, the weight-average molecular weight of the SBR is measured by the above-described measuring method.

A content of an SBR in the rubber component is preferably 30% by mass or more, more preferably 40% by mass or more, further preferably 50% by mass or more, particularly preferably 60% by mass or more, from the viewpoint of the effects of the present invention. Moreover, an upper limit value of the content is not particularly limited, but can be, for example, 99% by mass or less, 95% by mass or less, 90% by mass or less, or 85% by mass or less.

### (BR)

A BR is not particularly limited, and those common in the tire industry can be used such as, for example, a BR having a cis content of less than 50 mol % (a low cis BR), a BR having a cis content of 90 mol % or more (a high cis BR), a rare-earth-based butadiene rubber synthesized using a rare-earth element-based catalyst (a rare-earth-based BR), a BR containing a syndiotactic polybutadiene crystal (an SPB-containing BR), a modified BR (a high cis modified BR, a low cis modified BR), and the like. These BRs may be used alone, or two or more thereof may be used in combination.

As the high cis BR, for example, those commercially available from Zeon Corporation, UBE Corporation, JSR Corporation, etc. can be used. When the high cis BR is compounded, abrasion resistance can be improved. A cis content of the high cis BR is preferably 95 mol % or more, more preferably 96 mol % or more, further preferably 97 mol % or more. Besides, the cis content of the BR is measured by the above-described measuring method.

Among modified BRs, a BR modified at its terminal and/or main chain with a functional group comprising at least one element selected from the group consisting of nitrogen, oxygen, silicon, and sulfur can be appropriately used as an ionically bonded modified BR. Examples of the above-described functional group include those exemplified for the above-described modified SBR.

Examples of other modified BRs include those obtained by adding a tin compound after polymerizing 1,3-butadiene by a lithium initiator, the end of which is further bonded by tin-carbon bond (tin-modified BR), and the like. Moreover, the modified BR may be either non-hydrogenated or hydrogenated.

A weight-average molecular weight (Mw) of a BR is preferably 300,000 or more, more preferably 350,000 or more, further preferably 400,000 or more, from the viewpoint of abrasion resistance. Moreover, it is preferably 2,000,000 or less, more preferably 1,000,000 or less, from the viewpoints of cross-linking uniformity, etc. Besides, the Mw of the BR is measured by the above-described measuring method.

A content of a BR in the rubber component is preferably 1% by mass or more, more preferably 3% by mass or more, further preferably 5% by mass or more, further preferably 7% by mass or more, particularly preferably 10% by mass or more, from the viewpoint of ensuring abrasion resistance. Moreover, the content is preferably 50% by mass or less, more preferably 40% by mass or less, further preferably 30% by mass or less, particularly preferably 20% by mass or less, from the viewpoint of the effects of the present invention.

### (Other Rubber Components)

The rubber component may comprise rubber components other than diene-based rubbers (non-diene-based rubbers) as long as they do not affect the effects of the present invention. As the non-diene-based rubbers, rubber components commonly used in the tire industry can be used, examples of which include, for example, a butyl-based rubber, an ethylene-propylene rubber, a polynorbornene rubber, a silicone rubber, a polyethylene chloride rubber, a fluorine rubber (FKM), an acrylic rubber (ACM), a hydrin rubber, and the like. These other rubber components may be used alone, or two or more thereof may be used in combination. Moreover, besides the above-described rubber components, the rubber component may or may not comprise a known thermoplastic elastomer.

(Rubber Component Synthesized from Recycle-Derived/Biomass-Derived Raw Material)

A monomer that is a structural unit of a synthetic rubber such as an IR, a BR, an SBR, and the like may be one derived from underground resources such as petroleum, a natural gas, and the like, or a recycled one from a rubber product such as a tire and the like or a non-rubber product such as polystyrene and the like. A monomer obtained by recycling (a recycled monomer) is not particularly limited, examples of which include a recycle-derived polyisoprene, a recycle-derived butadiene, a recycle-derived aromatic vinyl compound, and the like. Examples of the butadiene include 1,2-butadiene, 1,3-butadiene, and the like. The above-described aromatic vinyl compound is not particularly limited, examples of which include styrene and the like. Among them, a recycle-derived polyisoprene (a recycled polyisoprene) a recycle-derived butadiene (a recycled butadiene) and/or a recycle-derived styrene (a recycled styrene) is preferably used as a raw material.

A method of producing a recycled monomer is not particularly limited, examples of which include, for example, a method of synthesizing a monomer from a recycle-derived naphtha obtained by decomposing a rubber product such as a tire and the like. Moreover, a method of producing a recycle-derived naphtha is not particularly limited, and a recycle-derived naphtha may be obtained by, for example, decomposing a rubber product such as a tire and the like under high temperature and pressure, by decomposing it by microwaves, or by extruding it after mechanically pulverizing it.

Furthermore, a monomer that is a structural unit of a synthetic rubber such as an IR, a BR, an SBR, and the like may be a biomass-derived one. In the present specification, biomass refers to a material derived from natural sources such as plants and the like. Biomass is not particularly limited, examples of which include, for example, agricultural, forestry and fishery products, sugar, wood waste, a plant residue after acquisition of a useful component, a plant-derived ethanol, a biomass naphtha, and the like.

The biomass-derived monomer (biomass monomer) is not particularly limited, examples of which include a biomass-derived butadiene, a biomass-derived aromatic vinyl compound, and the like. Examples of the butadiene include 1,2-butadiene, 1,3-butadiene, and the like. The above-described aromatic vinyl compound is not particularly limited, examples of which include styrene and the like. Moreover, a method of producing a biomass monomer is not particularly limited, examples of which include, for example, one by a biological and/or a chemical and/or a physical conversion of animals and plants, and the like. Amicrobial fermentation is representative of biological conversion, and examples of chemical and/or physical conversion include one due to a catalyst, one due to a high heat, one due to a high pressure, one due to an electromagnetic wave, one due to a critical fluid, and combinations thereof.

A polymer synthesized from a biomass monomer component (biomass polymer) is not particularly limited, examples of which include a polybutadiene rubber synthesized from a biomass-derived butadiene, an aromatic vinyl/butadiene copolymer synthesized from a biomass-derived butadiene and/or a biomass-derived aromatic vinyl compound, and the like. Examples of the aromatic vinyl/butadiene copolymer include, for example, a styrene-butadiene rubber synthesized from a biomass-derived butadiene and/or a biomass-derived styrene, and the like.

Whether a raw material of a polymer is derived from biomass can be determined by pMC (percent Modern Carbon) measured according to ASTM D6866-10.

pMC is a ratio of ¹⁴C concentration of a sample to ¹⁴C concentration of a modern standard carbon (modern standard reference) and a value used as an index indicating a biomass ratio of a compound. A significance of this value is mentioned below.

In 1 mole of carbon atoms (6.02×10²³ pieces), there are about 6.02×10^{11 14}C that are about one trillionth of the number of normal carbon atoms. A half-life of ¹⁴C is 5730 years, and ¹⁴C regularly decreases. It takes 226,000 years for all of them to decay. Thus, in fossil fuels such as coal, petroleum, a natural gas, and the like, where it is considered that 226,000 years or more have passed since carbon dioxide in the atmosphere was absorbed by plants to be fixed, all of ¹⁴C elements, which were contained in them at the beginning of fixation, decay. Therefore, in the present 21st century, fossil fuels such as coal, petroleum, a natural gas, and the like do not contain any ¹⁴C element. Therefore, chemical substances produced using these fossil fuels as raw materials do not contain any ¹⁴C element as well.

On the other hand, ¹⁴C is constantly generated by cosmic rays causing nuclear reactions in the atmosphere. From this, in ¹⁴C, a decrease in ¹⁴C due to radioactive decay and generation of ¹⁴C due to nuclear reactions are balanced, and the amount of ¹⁴C has been constant in the Earth's atmospheric environment. Thus, the ¹⁴C concentration of substances derived from biomass resources that have been circulating in the current environment becomes a value of about 1×10⁻¹² mol % based on total carbon atoms, as described above. Accordingly, by utilizing a difference between these values, a biomass ratio in a certain compound can be calculated.

This ¹⁴C is generally measured as follows. A ¹³C concentration (¹³C/¹²C) and a ¹⁴C concentration (¹⁴C/¹²C) are measured using an accelerator mass spectrometry based on a tandem accelerator. In the measurements, a ¹⁴C concentration in a circulating carbon in nature as of 1950 is adopted as the modern standard reference for the ¹⁴C concentration. As a specific reference material, an oxalic acid standard body provided by NIST (National Institute of Standards and Technology) is used. A specific radioactivity of carbon in this oxalic acid (radioactivity intensity of ¹⁴C per gram of carbon) is sorted for each carbon isotope, ¹³C is corrected to a constant value, and a value corrected for attenuation from 1950 to the date of measurement is used as a standard ¹⁴C concentration value (100%). A ratio of this value to a value actually measured for a sample becomes a pMC value.

Thus, if a rubber is produced from a material derived from 100% biomass, the ¹⁴C concentration shows a value of approximately 110 pMC as, currently, under a normal condition, it often does not reach 100, though there are regional differences and the like. On the other hand, if this ¹⁴C concentration is measured for a chemical substance derived from a fossil fuel such as petroleum and the like, it shows a value of approximately 0 pMC (for example, 0.3 pMC). This value corresponds to a biomass ratio of 0% as mentioned above.

From above, it is appropriate in terms of environmental protection to use a material such as a rubber having a high pMC value, and the like, that is, a material such as a rubber having a high biomass ratio, and the like, for a rubber composition.

### <Filler>

The rubber composition relating to the present embodiment comprises a filler. The filler relating to the present embodiment preferably comprises silica, more preferably comprises carbon black and silica, and may comprise a filler consisting only of carbon black and silica.

### (Silica)

Silica is not particularly limited, and those common in the tire industry can be used, such as, for example, silica prepared by a dry process (anhydrous silica), silica prepared by a wet process (hydrous silica), and the like. A raw material of silica is not particularly limited, and may be, for example, mineral-derived raw materials such as quartz and the like, bio-derived raw materials such as rice husks and the like (e.g., silica made from a biomass material such as rice husks and the like), or silica recycled from a product containing silica. Among them, hydrous silica prepared by a wet process is preferable from the reason that it has many silanol groups. These silica may be used alone, or two or more thereof may be used in combination.

Silica made from a biomass material can be obtained by, for example, burning rice husks to obtain rice husk ashes, extracting silicate from the rice husk ashes using a sodium hydroxide solution, generating silicon dioxide by reacting the silicate with sulfuric acid in the same manner as for a conventional wet silica, and filtering, washing with water, drying and pulverizing precipitates of the silicon dioxide.

As silica recycled from a product containing silica, for example, silica recovered from an electronic component such as a semiconductor and the like, a tire, a product containing silica such as a desiccant, a filtering material such as diatomaceous earth and the like, etc. can be used. Moreover, a recovering method is not particularly limited, examples of which include pyrolysis, decomposition by electromagnetic waves, and the like. Among them, silica recovered from an electronic component such as a semiconductor and the like or from a tire is preferable.

When silica crystallizes, it is insoluble in water, and silicic acid that is a component thereof cannot be used. By controlling a burning temperature and a burning time, crystallization of silica in rice husk ashes can be suppressed (JP 2009-2594 A, Akita Prefectural University Web Journal B/2019, vol. 6, p.216-222, etc.).

As an amorphous silica extracted from rice husks, those commercially available from Wilmar, etc. can be used.

A nitrogen adsorption specific surface area (N₂SA) of silica is preferably 110 m²/g or more, more preferably 130 m²/g or more, further preferably 150 m²/g or more, particularly preferably 170 m²/g or more, from the viewpoints of reinforcing property, breaking strength, and abrasion resistance. Moreover, it is preferably 350 m²/g or less, more preferably 300 m²/g or less, further preferably 250 m²/g or less, from the viewpoints of heat generation and processability. Besides, the N₂SA of silica is measured by the above-described measuring method.

An average primary particle size of silica is preferably 20 nm or less, more preferably 19 nm or less, further preferably 18 nm or less, particularly preferably 17 nm or less, from the viewpoint of increasing a specific surface area of silica to increase an interaction with a rubber component, suppress movement of a molecular chain, and suppress heat generation. A lower limit value of the average primary particle size is, but not particularly limited to, preferably 1 nm or more, more preferably 3 nm or more, further preferably 5 nm or more, from the viewpoint of dispersibility of silica. Besides, the average primary particle size of silica is measured by the above-described measuring method.

A content of silica based on 100 parts by mass of the rubber component is preferably 5 parts by mass or more, more preferably 20 parts by mass or more, further preferably 40 parts by mass or more, particularly preferably 60 parts by mass or more, from the viewpoint of reinforcing property. Moreover, it is preferably 200 parts by mass or less, more preferably 160 parts by mass or less, further preferably 120 parts by mass or less, particularly preferably 100 parts by mass or less, from the viewpoint of processability and weight reduction of a rubber.

### (Carbon Black)

Examples of carbon black include, but not particularly limited to, N134, N110, N220, N234, N219, N339, N330, N326, N351, N550, N762, and the like. A raw material of carbon black may be a biomass material such as lignin, a vegetable oil, and the like, or may be a pyrolysis oil obtained by pyrolyzing a waste tire. Moreover, a method of producing carbon black may be one by combustion such as a furnace method and the like, one by hydrothermal carbonization (HTC), or one by pyrolysis of methane such as a thermal black method and the like. As commercially available products, products from, Asahi Carbon Co., Ltd., Cabot Japan K.K., Tokai Carbon Co., Ltd., Mitsubishi Chemical Corporation, Lion Corporation, NIPPON STEEL Carbon Co. Ltd., Columbia Chemical Corporation, etc. can be used. These carbon black may be used alone, or two or more thereof may be used in combination.

Moreover, besides the above-described carbon black, from the viewpoint of life cycle assessment, carbon black made from a biomass material such as lignin and the like or a recovered carbon black obtained by pyrolyzing and refining a product including carbon black such as a tire and the like may be used as carbon black.

In the present specification, a “recovered carbon black” refers to carbon black obtained by pulverizing a product such as a used tire comprising carbon black and the like and baking the pulverized product, in which, when the product is subjected to oxidative combustion by heating in the air, using a thermal weight measurement method according to JIS K 6226-2:2003, a ratio of a mass of ash (ash content), which is a component that does not combust, is 13% by mass or more. That is, a ratio of a mass (carbon amount) of a weight loss content due to the oxidative combustion of the recovered carbon black is 87% by mass or less. The recovered carbon black may be expressed by rCB.

The recovered carbon black can be obtained from a pyrolysis process of a used pneumatic tire. For example, EP 3427975 A describes, with reference to “Rubber Chemistry and Technology”, Vol. 85, No. 3, Pages 408 to 449 (2012), in particular, Pages 438, 440, and 442, that the recovered carbon black can be obtained by pyrolysis of an organic material at 550 to 800° C., excluding oxygen, or by vacuum pyrolysis at a relatively low temperature ([0027]). Such carbon black obtained from the pyrolysis process usually lacks a functional group on its surface, as mentioned in [0004] of JP 6856781 B (A comparison of surface morphology and chemistry of pyrolytic carbon blacks with commercial carbon blacks, Powder Technology 160 (2005) 190-193).

The recovered carbon black may lack a functional group on its surface or may be treated so that its surface comprises a functional group. The treatment performed so that the surface of the recovered carbon black comprises a functional group can be implemented by a conventional method. For example, in EP 3173251 A, carbon black comprising a hydroxyl and/or carboxyl group on its surface is obtained by treating carbon black obtained from a pyrolysis process with potassium permanganate under an acidic condition. Moreover, in JP 6856781 B, carbon black whose surface is activated is obtained by treating carbon black obtained from a pyrolysis process with an amino acid compound comprising at least one thiol group or disulfide group. The recovered carbon black relating to the present embodiment also comprises carbon black whose surface has been treated so as to comprise a functional group.

As the recovered carbon black, those commercially available from Strebl Green Carbon Pte Ltd., LDC Co., Ltd., etc. can be used.

A nitrogen adsorption specific surface area (N₂SA) of carbon black is preferably 50 m²/g or more, more preferably 80 m²/g or more, further preferably 100 m²/g or more, from the viewpoints of weather resistance and reinforcing property. Moreover, it is preferably 250 m²/g or less, more preferably 220 m²/g or less, further preferably 190 m²/g or less, from the viewpoints of dispersibility, fuel efficiency, fracture characteristics, and durability. Besides, the N₂SA of carbon black is measured by the above-described measuring method.

An average primary particle size of carbon black is preferably 32 nm or less, more preferably 28 nm or less, further preferably 26 nm or less, particularly preferably 22 nm or less. Moreover, the average primary particle size is preferably 8 nm or more, more preferably 10 nm or more, further preferably 12 nm or more, particularly preferably 14 nm or more. Besides, the average primary particle size of carbon black is measured by the above-described measuring method.

A content of carbon black when compounded based on 100 parts by mass of the rubber component is preferably 1 part by mass or more, more preferably 3 parts by mass or more, further preferably 5 parts by mass or more, from the viewpoints of weather resistance and reinforcing property. Moreover, it is preferably 30 parts by mass or less, more preferably 25 parts by mass or less, further preferably 20 parts by mass or less, particularly preferably 15 parts by mass or less, from the viewpoint of fuel efficiency.

### (Other Fillers)

Fillers other than silica and carbon black are not particularly limited, and, for example, those conventionally and commonly used in the tire industry can be compounded such as aluminum hydroxide, alumina (aluminum oxide), calcium carbonate, magnesium sulfate, talc, clay, biochar (BIOCHAR), and the like. These other fillers may be used alone, or two or more thereof may be used in combination.

A ratio of a content of carbon black to a content of silica is preferably 0.40 or less, more preferably 0.33 or less, further preferably 0.25 or less, further preferably 0.20 or less, particularly preferably 0.15 or less. When the ratio of the content of carbon black to the content of silica is within the above-described ranges, fuel efficiency can be further improved. On the other hand, a lower limit value of the ratio of the content of carbon black to the content of silica is not particularly limited, and it can be, for example, 0.01 or more, 0.02 or more, or 0.05 or more, in which the filler may not comprise carbon black.

A total content of fillers based on 100 parts by mass of the rubber component is 45 parts by mass or more, preferably 55 parts by mass or more, more preferably 65 parts by mass or more, further preferably 70 parts by mass or more, from the viewpoint of securing reinforcing property when drying. Moreover, the content is preferably 200 parts by mass or less, more preferably 160 parts by mass or less, further preferably 120 parts by mass or less, particularly preferably 100 parts by mass or less, from the viewpoints of fuel efficiency and processability.

### (Silane Coupling Agent)

When silica is used, it is preferably used in combination with a silane coupling agent. Examples of the silane coupling agent include, but not particularly limited to, for example, sulfide-based silane coupling agents such as bis(3-triethoxysilylpropyl)disulfide, bis(3-triethoxysilylpropyl)tetrasulfide, and the like; mercapto-based silane coupling agents such as 3-mercaptopropyltrimethoxysilane, 3-mercaptopropyltriethoxysilane, 2-mercaptoethyltrimethoxysilane, 2-mercaptoethyltriethoxysilane, and the like; vinyl-based silane coupling agents such as vinyltriethoxysilane, vinyltrimethoxysilane, and the like; amino-based silane coupling agents such as 3-aminopropyltriethoxysilane, 3-aminopropyltrimethoxysilane, N-2-(aminoethyl)-3-aminopropyltrimethoxysilane, N-2-(aminoethyl)-3-aminopropyltriethoxysilane, N-phenyl-3-aminopropyltrimethoxysilane, and the like; glycidoxy-based silane coupling agents such as γ-glycidoxypropyltriethoxysilane, γ-glycidoxypropyltrimethoxysilane, and the like; nitro-based silane coupling agents such as 3-nitropropyltrimethoxysilane, 3-nitropropyltriethoxysilane, and the like; chloro-based silane coupling agents such as 3-chloropropyltrimethoxysilane, 3-chloropropyltriethoxy, and the like; as well as quaternary ammonium salt-based silane coupling agents such as an aqueous silane coupling agent having a quaternary ammonium salt in an organic functional group and the like; and the like. Among them, amino-based silane coupling agents, glycidoxy-based silane coupling agents, and quaternary ammonium salt-based silane coupling agents can be appropriately used as ionically bonded modified silane coupling agents. As silane coupling agents, for example, those commercially available from Evonik Industries AG, Momentive Performance Materials, Shin-Etsu Chemical Co., Ltd., Topco Technologies Corporation, etc. can be used. These silane coupling agents may be used alone, or two or more thereof may be used in combination.

A content of a silane coupling agent based on 100 parts by mass of silica is preferably 1.0 parts by mass or more, more preferably 3.0 parts by mass or more, further preferably 5.0 parts by mass or more, particularly preferably 7.0 parts by mass or more, from the viewpoint of enhancing dispersibility of silica. Moreover, it is preferably 20 parts by mass or less, more preferably 15 parts by mass or less, from the viewpoints of cost and processability.

### (Other Compounding Agents)

The rubber composition relating to the present embodiment can appropriately comprise compounding agents conventionally and generally used in the tire industry, for example, a plasticizer, a vulcanized rubber particle, processing aid, wax, an antioxidant, stearic acid, zinc oxide, a vulcanizing agent, a vulcanization accelerator, and the like, in addition to the above-described components.

The plasticizer is a material that imparts plasticity to the rubber component, and has a concept that includes both a plasticizer that is liquid at 25° C. and a plasticizer that is solid at a normal temperature (25° C.). Examples of the plasticizer include, a resin component, oil, a liquid polymer, an ester-based plasticizer, and the like. These plasticizers may be ones derived from mineral resources such as petroleum, a natural gas, and the like, or naphtha-derived ones recycled from a rubber product or a non-rubber products. Moreover, a hydrocarbon component having a low-molecular weight obtained by pyrolyzing a used tire or a product comprising various components and performing extraction from the pyrolysate may be used as a plasticizer. Among these plasticizers, one modified with a functional group comprising at least one element selected from the group consisting of nitrogen, oxygen, silicon, and sulfur can be appropriately used as an ionically bonded modified plasticizer. These plasticizers may be used alone, or two or more thereof may be used in combination.

### (Resin Component)

A resin component is not particularly limited as long as it is a resin component commonly used in the tire industry, examples of which include, for example, an adhesive resin such as a rosin-based resin, a terpene-based resin, a dicyclopentadiene-based resin, an aromatic vinyl resin, a C9-based resin, a C5-based resin, a C5/C9-based resin, a phenol-based resin, and the like. Among them, a rosin-based resin can be appropriately used as an ionically bonded modified resin, as it has a carboxyl group. These resin components may be used alone, or two or more thereof may be used in combination.

A “rosin-based resin” refers to a resin comprising a rosin acid compound such as abietic acid, neoabietic acid, palustric acid, isopimaric acid, and the like, and may be one obtained by hydrogenating or modifying them. Example of the rosin-based resin include, but not particularly limited to, for example, a natural resin rosin and a rosin-modified resin obtained by modifying it by hydrogenation, disproportionation, dimerization, esterification, etc., and the like. These rosin-based resins may be used alone, or two or more thereof may be used in combination.

A “terpene-based resin” refers to a resin comprising a terpene compound such as α-pinene, β-pinene, limonene, dipentene, and the like as a monomer component having the largest content, and may be one obtained by hydrogenating or modifying them. Specific examples of the terpene-based resin include, for example, a polyterpene resin comprising only one or more of the terpene compounds as monomer components; an aromatic-modified terpene resin comprising the terpene compound and an aromatic compound as monomer components; a terpene phenolic resin comprising the terpene compound and a phenol-based compound as monomer components; and the like. Examples of the aromatic compound used as a monomer component for the aromatic-modified terpene resin include, for example, styrene, α-methylstyrene, vinyltoluene, divinyltoluene, and the like. Examples of the phenol-based compound used as a monomer component for the terpene phenolic resin include, for example, phenol, bisphenol A, cresol, xylenol, and the like. These terpene-based resins may be used alone, or two or more thereof may be used in combination.

A “dicyclopentadiene-based resin” refers to a resin comprising cyclopentadiene (CPD) or dicyclopentadiene (DCPD) as a monomer component and may be one obtained by hydrogenating or modifying them. Examples of the dicyclopentadiene-based resin include, for example, a DCPD/C9 resin comprising dicyclopentadiene and a C9 fraction that will be described later as monomer components (the DCPD/C9 resin may be one obtained by hydrogenating or modifying them) and the like, preferably a DCPD/C9 resin comprising dicyclopentadiene and styrene as monomer components. more preferably a DCPD/C9 resin comprising dicyclopentadiene, styrene, and indene as monomer components. As the dicyclopentadiene-based resin, for example, those commercially available from Exxon Mobil Corporation, ENEOS Corporation, Zeon Corporation, Maruzen Petrochemical Co., Ltd., etc. can be used. These dicyclopentadiene-based resins may be used alone, or two or more thereof may be used in combination.

An “aromatic vinyl-based resin” refers to a resin comprising an aromatic vinyl compound such as styrene, α-methylstyrene, vinyltoluene, p-chlorostyrene, and the like as a monomer component having the largest content, and may be one obtained by hydrogenating or modifying them. As the aromatic vinyl-based resin, a homopolymer of α-methylstyrene or styrene or a copolymer of α-methylstyrene and styrene is preferable, and a copolymer of α-methylstyrene and styrene is more preferable, because it is economical, easy to process, and excellent in heat generation. As the aromatic vinyl-based resin, for example, those commercially available from Kraton Corporation, Eastman Chemical Company, Mitsui Chemicals, Inc., etc. can be used. These aromatic vinyl-based resins may be used alone, or two or more thereof may be used in combination.

A “C9-based resin” refers to a resin obtained by polymerizing C9 fractions and may be a resin obtained by polymerizing a C9 fraction alone or a copolymer obtained by copolymerizing a C9 fraction with other components. For example, a resin obtained by copolymerizing dicyclopentadiene (DCPD) with a C9 fraction is referred to as a DCPD/C9 resin. Moreover, it may be one obtained by hydrogenating or modifying them. Examples of the C9 fraction include, for example, a petroleum fraction having 8 to 10 carbon atoms such as vinyltoluene, alkylstyrene, coumarone, indene, methylindene, dicyclopentadiene, and the like. These C9-based resins may be used alone, or two or more thereof may be used in combination.

A “C5-based resin” refers to a resin obtained by polymerizing C5 fractions and may be one obtained by hydrogenating or modifying them. Examples of the C5 fraction include, for example, a petroleum fraction having 4 to 5 carbon atoms such as cyclopentadiene, isoprene, pentane, isopentane, neopentane, pentene, pentadiene, and the like. These C5-based resins may be used alone, or two or more thereof may be used in combination.

A “C5/C9-based resin” refers to a resin obtained by copolymerizing the C5 fraction and the C9 fraction and may be one obtained by hydrogenating or modifying them. As the C5/C9-based petroleum resin, for example, those commercially available from Tosoh Corporation, Zibo Luhua Hongjin New Material Group Co., Ltd, etc. can be appropriately used. These C5/C9-based resins may be used alone, or two or more thereof may be used in combination.

A “phenol-based resin” refers to a resin comprising a phenolic compound such as phenol, cresol, and the like as a monomer component having the largest content. Examples of the phenol-based resin include, but not particularly limited to, a phenol formaldehyde resin, an alkylphenol formaldehyde resin, an alkylphenol acetylene resin, an oil-modified phenol formaldehyde resin, and the like. These phenol-based resins may be used alone, or two or more thereof may be used in combination.

A softening point of a resin component is preferably 60° C. or higher, more preferably 70° C. or higher, further preferably 80° C. or higher, from the viewpoint of grip performance. Moreover, it is preferably 150° C. or lower, more preferably 140° C. or lower, further preferably 130° C. or lower, from the viewpoints of processability and improvement in dispersibility of a rubber component with a filler. Besides, the softening point of the resin component is measured by the above-described measuring method.

A content of a resin component when compounded based on 100 parts by mass of the rubber component is preferably 1 part by mass or more, more preferably 5 parts by mass or more, further preferably 10 parts by mass or more, particularly preferably 12 parts by mass or more. Moreover, it is preferably 50 parts by mass or less, more preferably 40 parts by mass or less, further preferably 30 parts by mass or less, from the viewpoint of suppressing heat generation.

### (Oil)

Examples of oil include, for example, a mineral oil, a vegetable oil, an animal oil, and the like. Moreover, from the viewpoint of life cycle assessment, those obtained by purifying a waste oil after being used in a rubber mixer or an engine, or a waste cooking oil used in a restaurant may be used.

In the present specification, a mineral oil refers to oil derived from mineral resources such as petroleum, a natural gas, and the like. Examples of the mineral oil include paraffinic oils (mineral oils), naphthenic oils, aromatic oils, and the like. Specific examples of the mineral oil include, for example, MES (Mild Extracted Solvate), DAE (Distillate Aromatic Extract), TDAE (Treated Distillate Aromatic Extract), TRAE (Treated Residual Aromatic Extract), RAE (Residual al Aromatic Extract), and the like. Moreover, as an environmental measure, an oil having a low content of a polycyclic aromatic compound (PCA) can also be used. Examples of the oil having a low content of a PCA content include MES, TDAE, a heavy naphthenic oil, and the like.

In the present specification, examples of the “vegetable oil” include, for example, a linseed oil, a rapeseed oil, a safflower oil, a soybean oil, a corn oil, a cottonseed oil, a rice oil, a tall oil, a sesame oil, a perilla oil, a castor oil, a tung oil, a pine oil, a pine tar oil, a sunflower oil, a coconut oil, a palm oil, a palm kernel oil, an olive oil, a camellia oil, a jojoba oil, a macadamia nut oil, a peanut oil, a grapeseed oil, a Japan wax, and the like. Furthermore, examples of the vegetable oil also include a refined oil obtained by refining the above-described oil (a salad oil, etc.), a transesterified oil obtained by transesterifying the above-described oil, a hydrogenated oil obtained by hydrogenating the above-described oil, a thermally polymerized oil obtained by thermally polymerizing the above-described oil, an oxidized polymerized oil obtained by oxidizing the above-described oil, a waste cooking oil obtained by recovering what was utilized as an edible oil, etc., and the like. Besides, the vegetable oil may be liquid or solid at a normal temperature (25° C.). These vegetable oils may be used alone, or two or more thereof may be used in combination.

The vegetable oil relating to the present embodiment preferably comprises acylglycerol, and more preferably comprises triacylglycerol. Besides, in the present specification, acylglycerol refers to a compound in which a hydroxy group of glycerin and a fatty acid are ester-bonded. Acylglycerol is not particularly limited, and may be any of 1-monoacylglycerol, 2-monoacylglycerol, 1,2-diacylglycerol, 1,3-diacylglycerol, and triacylglycerol. Furthermore, acylglycerol may be a monomer, a dimer, or a multimer that is a trimer or higher. Besides, acylglycerol that is a dimer or higher can be obtained by thermal polymerization, oxidative polymerization, or the like. In addition, acylglycerol may be liquid or solid at a normal temperature (25° C.).

As a method of confirming whether the rubber composition comprises the above-described acylglycerol, the confirmation can be performed by, but not particularly limited to, for example, ¹H-NMR measurement below. Specifically, a rubber composition comprising triacylglycerol is immersed in a heavy chloroform at normal temperature (25° C.) for 24 hours and removed to measure ¹H-NMR at a normal temperature, and when a signal of tetramethylsilane (TMS) is defined as 0.00 ppm, signals near 5.26 ppm, near 4.28 ppm, and near 4.15 ppm are observed, the signals being presumed to be derived from hydrogen atoms bonded to carbon atoms adjacent to oxygen atoms of an ester group. Besides, “near” in this paragraph shall be a range of ±0.10 ppm.

The above-described fatty acid is not particularly limited and may be an unsaturated fatty acid or a saturated fatty acid. Examples of the unsaturated fatty acid include a monounsaturated fatty acid such as oleic acid and the like, and a polyunsaturated fatty acid such as linoleic acid, linolenic acid, and the like. Moreover, examples of the saturated fatty acid include butyric acid, lauric acid, and the like.

Among them, as the fatty acid, a fatty acid having few double bonds, that is, a saturated fatty acid or a monounsaturated fatty acid is desired, and oleic acid is preferable. As a vegetable oil comprising such fatty acid, for example, a vegetable oil comprising a saturated fatty acid or a monounsaturated fatty acid may be used, or a vegetable oil modified by transesterification or the like may be used. Moreover, in order to produce a vegetable oil comprising such fatty acid, a plant may be improved by selective breeding, gene recombination, or the like.

As the vegetable oil, for example, those commercially available from Idemitsu Kosan Co., Ltd., Sankyo Yuka Kogyo K.K., ENEOS Corporation, Olisoy, H&R Group, Hokoku Corporation, Fuji Kosan Co., Ltd., The Nisshin OilliO Group, Ltd., etc. can be used.

Examples of the animal oil include a fish oil, a beef tallow, an oleyl alcohol derived therefrom, or the like.

A content of oil based on 100 parts by mass of the rubber component (a total amount of a plurality of oils when used in combination) is preferably 1 part by mass or more, more preferably 5 parts by mass or more, further preferably 10 parts by mass or more, particularly preferably 12 parts by mass or more, from the viewpoint of processability. Moreover, it is preferably 50 parts by mass or less, more preferably 40 parts by mass or less, further preferably 30 parts by mass or less, from the viewpoint of rubber hardness.

### (Liquid Polymer)

The liquid polymer is not particularly limited as long as it is a polymer in a liquid state at normal temperature (25° C.), examples of which include, for example, a liquid butadiene polymer (liquid BR), a liquid isoprene polymer (liquid IR), a liquid styrene-butadiene copolymer (liquid SBR), a liquid styrene-isoprene copolymer (liquid SIR), a polymer comprising myrcene or farnesene, and the like. Among these liquid polymers, those modified at its terminal and/or main chain with a functional group comprising at least one element selected from the group consisting of nitrogen, oxygen, silicon, and sulfur can be appropriately used as ionically bonded modified liquid polymers. Examples of the above-described functional group include those exemplified for the above-described modified SBR. As the liquid polymers, those manufactured by Kuraray Co., Ltd., and the like can be used. These liquid polymers may be used alone, or two or more thereof may be used in combination.

A content of a liquid polymer when compounded based on 100 parts by mass of the rubber component is preferably 1 part by mass or more, more preferably 5 parts by mass or more, further preferably 10 parts by mass or more, particularly preferably 12 parts by mass or more. Moreover, the content of the liquid polymer is preferably 50 parts by mass or less, more preferably 40 parts by mass or less, further preferably 30 parts by mass or less.

### (Ester-Based Plasticizer)

Examples of the ester-based plasticizer include, for example, dibutyl adipate (DBA), diisobutyl adipate (DIBA), dioctyl adipate (DOA), bis(2-ethylhexyl) azelate (DOZ), dibutyl sebacate (DBS), diisononyl adipate (DINA), diethyl phthalate (DEP), dioctyl phthalate (DOP), diundecyl phthalate (DUP), dibutyl phthalate (DBP), dioctyl sebacate (DOS), tributyl phosphate (TBP), trioctyl phosphate (TOP), triethyl phosphate (TEP), trimethyl phosphate (TMP), thymidine triphosphate (TTP), tricresyl phosphate (TCP), trixylenyl phosphate (TXP), and the like. These ester-based plasticizers may be used alone, or two or more thereof may be used in combination.

A content of a plasticizer based on 100 parts by mass of the rubber component (a total amount of a plurality of plasticizers when used in combination) is preferably 5 parts by mass or more, more preferably 10 parts by mass or more, further preferably 15 parts by mass or more, further preferably 20 parts by mass or more, particularly preferably 25 parts by mass or more. Moreover, the content is preferably 100 parts by mass or less, more preferably 80 parts by mass or less, further preferably 60 parts by mass or less, particularly preferably 50 parts by mass or less.

Besides, when any one or more of the above-described rubber component, silica, resin component, and liquid polymer are modified with a carboxyl group, various metal salts may be compounded in order to form ionic bonds in the rubber composition. Examples of these metal salts include: metal carbonates such as lithium carbonate, sodium carbonate, potassium carbonate, rubidium carbonate, cesium carbonate, beryllium carbonate, magnesium carbonate, calcium carbonate, strontium carbonate, barium carbonate, lithium carbonate, and the like; metal acetates such as sodium acetate, potassium acetate, rubidium acetate, cesium acetate, beryllium acetate, magnesium acetate, calcium acetate, strontium acetate, barium acetate, and the like; fatty acid metal salts other than metal acetates such as sodium stearate, magnesium stearate, calcium stearate, barium stearate, sodium oleate, magnesium oleate, calcium oleate, barium oleate, and the like; metal phenoxides such as lithium phenoxide, sodium phenoxide, potassium phenoxide, rubidium phenoxide, cesium phenoxide, beryllium diphenoxide, magnesium diphenoxide, calcium diphenoxide, strontium diphenoxide, barium diphenoxide, and the like; and the like.

A content of a metal salt based on 100 parts by mass of the rubber component is preferably 1 part by mass or more, more preferably 3 parts by mass or more, further preferably 5 parts by mass or more. Moreover, the content is preferably 30 parts by mass or less, more preferably 20 parts by mass or less, further preferably 15 parts by mass or less, particularly preferably 12 parts by mass or less.

### (Vulcanized Rubber Particle)

A vulcanized rubber particle is a particle made of a vulcanized rubber, and specifically, a rubber powder and the like specified in JIS K 6316:2017 can be used. From the viewpoints of environmental considerations and costs, a recycled rubber powder produced from a pulverized product of a waste tire or the like is preferable. They may be used alone, or two or more thereof may be used in combination.

The vulcanized rubber particle is not particularly limited and may be a non-modified vulcanized rubber particle or a modified vulcanized rubber particle. As commercially available products of vulcanized rubbers, for example, products from Lehigh Technologies, Muraoka Rubber Reclaiming Co., Ltd., etc. can be used.

A content of a vulcanized rubber particle when compounded based on 100 parts by mass of the rubber component can be appropriately adjusted, for example, within a range of greater than 1 part by mass and less than 80 parts by mass.

### (Processing Aid)

Examples of processing aid include, for example, a fatty acid metal salt, a fatty acid amide, an amide ester, a silica surface active agent, a fatty acid ester, a mixture of a fatty acid metal salt and an amide ester, a mixture of a fatty acid metal salt and a fatty acid amide, and the like. As processing aid, for example, those commercially available from Schill+Seilacher GmbH, Performance Additives, etc. can be used. These processing aid may be used alone, or two or more thereof may be used in combination.

A content of processing aid when compounded based on 100 parts by mass of the rubber component is preferably greater than 0.5 parts by mass, more preferably greater than 1 part by mass, further preferably greater than 1.5 parts by mass, from the viewpoint of exhibiting an effect of improving processability. Moreover, it is preferably less than 10 parts by mass, more preferably less than 8.0 parts by mass, further preferably less than 5.0 parts by mass, from the viewpoints of abrasion resistance and breaking strength.

### (Wax)

Wax is not particularly limited, and any of those commonly used in the tire industry can be appropriately used, examples of which include, for example, a mineral-based wax, a plant-derived wax, and the like. The mineral-based wax refers to wax derived from mineral resources such as oil, a natural gas, and the like. The plant-derived wax refers to wax derived from natural resources such as a plant and the like. Among them, the mineral-based wax is preferable. Examples of the plant-derived wax include, for example, a rice wax, a carnauba wax, a candelilla wax, and the like. Examples of the mineral-based wax include, for example, a paraffin wax, a microcrystalline wax, specially selected waxes thereof, and the like. Among them, a paraffin wax is preferable. Besides, wax relating to the present embodiment shall not comprise stearic acid. As wax, for example, those commercially available from Ouchi Shinko Chemical Industry Co., Ltd., Nippon Seiro Co., Ltd., Paramelt B.V., etc. can be used. These waxes may be used alone, or two or more thereof may be used in combination.

A content of wax when compounded based on 100 parts by mass of the rubber component is preferably 0.5 parts by mass or more, more preferably 1.0 parts by mass or more, further preferably 1.5 parts by mass or more, from the viewpoint of weather resistance of a rubber. Moreover, it is preferably 10 parts by mass or less, more preferably 5.0 parts by mass or less, from the viewpoint of preventing whitening of a tire due to bloom.

### (Antioxidant)

Examples of the antioxidant include, but not particularly limited to, a naphthylamine-based antioxidant such as phenyl-α-naphthylamine and the like; a diphenylamine-based antioxidant such as an octylated diphenylamine, 4,4′-bis(α,α′-dimethylbenzyl)diphenylamine, and the like; p-phenylenediamine-based antioxidant such as N-isopropyl-N′-phenyl-p-phenylenediamine, N-(1,3-dimethylbutyl)-N′-phenyl-p-phenylenediamine (6PPD), N,N′-bis(1,4-dimethylpentyl)-p-phenylenediamine (77PD), N,N′-diphenyl-p-phenylenediamine (DPPD), N,N′-ditolyl-p-phenylenediamine (DTPD), N-isopropyl-N′-phenyl-p-phenylenediamine (IPPD), N,N′-di-2-naphthyl-p-phenylenediamine (DNPD), and the like; a quinoline-based antioxidant such as a polymer of 2,2,4-trimethyl-1,2-dihydroquinoline and the like; a monophenol-based antioxidant such as 2,6-di-t-butyl-4-methylphenol, a styrenated phenol, and the like; bis-, tris-, and polyphenol-based antioxidants such as tetrakis-[methylene-3-(3′,5′-di-t-butyl-4′-hydroxyphenyl)propionate]methane and the like. Among them, p-phenylenediamine-based antioxidants and quinoline-based antioxidants are preferable, and polymers of N-(1,3-dimethylbutyl)-N′-phenyl-p-phenylenediamine and 2,2,4-trimethyl-1,2-dihydroquinoline are more preferable. As commercially available products, for example, products manufactured by Seiko Chemical Co., Ltd., Sumitomo Chemical Co., Ltd., Ouchi Shinko Chemical Industry Co., Ltd., Flexsys, etc. can be used. These antioxidants may be used alone, or two or more thereof may be used in combination.

A content of an antioxidant when compounded based on 100 parts by mass of the rubber component is preferably 0.5 parts by mass or more, more preferably 1.0 parts by mass or more, further preferably 1.5 parts by mass or more, from the viewpoint of ozone crack resistance of a rubber. Moreover, it is preferably 10 parts by mass or less, more preferably 5.0 parts by mass or less, from the viewpoint of abrasion resistance.

A content of stearic acid when compounded based on 100 parts by mass of the rubber component is preferably 0.5 parts by mass or more, more preferably 1.0 parts by mass or more, further preferably 1.5 parts by mass or more, from the viewpoint of processability. Moreover, it is preferably 10 parts by mass or less, more preferably 5.0 parts by mass or less, from the viewpoint of vulcanization rate.

A content of zinc oxide when compounded based on 100 parts by mass of the rubber component is preferably 0.5 parts by mass or more, more preferably 1.0 parts by mass or more, further preferably 1.5 parts by mass or more, from the viewpoint of processability. Moreover, it is preferably 10 parts by mass or less, more preferably 5.0 parts by mass or less, from the viewpoint of abrasion resistance.

### (Vulcanizing Agent)

Sulfur is appropriately used as a vulcanizing agent. As sulfur, a powdery sulfur, an oil processing sulfur, a precipitated sulfur, a colloidal sulfur, an insoluble sulfur, a highly dispersible sulfur, and the like can be used.

A content of sulfur when compounded as a vulcanizing agent based on 100 parts by mass of the rubber component is preferably greater than 0.1 parts by mass, more preferably greater than 0.5 parts by mass, further preferably greater than 1.0 parts by mass, from the viewpoint of securing a sufficient vulcanization reaction. Moreover, it is preferably less than 5.0 parts by mass, more preferably less than 4.0 parts by mass, further preferably less than 3.5 parts by mass, from the viewpoint of preventing deterioration. Moreover, the content of the vulcanizing agent is preferably 3.0 parts by mass or less, more preferably less than 2.5 parts by mass, further preferably less than 2.0 parts by mass, particularly preferably 1.5 parts by mass or less, in order to reduce a density of a sulfur crosslink, from the viewpoint of the effects of the present invention. Besides, a content of a vulcanizing agent when an oil-containing sulfur is used as the vulcanizing agent shall be a total content of pure sulfur comprised in the oil-containing sulfur.

Examples of vulcanizing agents other than sulfur include, for example, an alkylphenol-sulfur chloride condensate, sodium hexamethylene-1,6-bisthiosulfate dihydrate, 1,6-bis(N,N′-dibenzylthiocarbamoyldithio)hexane, and the like. As these vulcanizing agents other than sulfur, those commercially available from Taoka Chemical Co., Ltd., LANXESS, Flexsys, etc. can be used. The vulcanizing agents other than sulfur may be used alone, or two or more thereof may be used in combination.

### (Vulcanization Accelerator)

Examples of the vulcanization accelerator include, for example, a sulfenamide-based vulcanization accelerator, a thiazole-based vulcanization accelerator, a guanidine-based vulcanization accelerator, a thiuram-based vulcanization accelerator, a dithiocarbamate-based vulcanization accelerator, a caprolactam disulfide, and the like. These vulcanization accelerators may be used alone, or two or more thereof may be used in combination. Among them, one or more vulcanization accelerators selected from the group consisting of sulfenamide-based, thiazole-based, and guanidine-based vulcanization accelerators are preferable, and a combination of a sulfenamide-based vulcanization accelerator and a guanidine-based vulcanization accelerator is more preferable, from the viewpoint that a desired effect can be obtained more appropriately.

Examples of a sulfenamide-based vulcanization accelerator include, for example, N-tert-butyl-2-benzothiazolylsulfenamide (TBBS), N-cyclohexyl-2-benzothiazolylsulfenamide (CBS), N,N-dicyclohexyl-2-benzothiazolylsulfenamide (DCBS), and the like. Among them, TBBS and CBS are preferable.

Examples of the thiazole-based vulcanization accelerator include, for example, 2-mercaptobenzothiazole (MBT) or a salt thereof, di-2-benzothiazolyl disulfide (MBTS), 2-(2,4-dinitrophenyl)mercaptobenzothiazole, 2-(2,6-diethyl-4-morpholinothio)benzothiazole, and the like. Among them, MBTS and MBT are preferable, and MBTS is more preferable.

Examples of the guanidine-based vulcanization accelerator include, for example, 1,3-diphenylguanidine (DPG), 1,3-di-o-tolylguanidine, 1-o-tolylbiguanide, di-o-tolylguanidine salt of dicatecholborate, 1,3-di-o-cumenylguanidine, 1,3-di-o-biphenylguanidine, 1,3-di-o-cumenyl-2-propionylguanidine, and the like. Among them, DPG is preferable.

A content of a vulcanization accelerator when compounded based on 100 parts by mass of the rubber component is preferably 0.5 parts by mass or more, more preferably 1.0 parts by mass or more, further preferably 1.5 parts by mass or more. Moreover, the content of the vulcanization accelerator based on 100 parts by mass of the rubber component is preferably 8.0 parts by mass or less, more preferably 6.0 parts by mass or less, further preferably 4.0 parts by mass or less. When the content of the vulcanization accelerator is within the above-described ranges, breaking strength and elongation tend to be secured.

In the present specification, various materials comprising carbon atoms (for example, a rubber, oil, a resin component, a vulcanization accelerator, an antioxidant, etc.) may be derived from carbon dioxide in the atmosphere. These various materials can be obtained from carbon dioxide by converting carbon dioxide directly or converting methane obtained via a process of methanation by which methane is synthesized from carbon dioxide.

### [Production of Rubber Composition and Tire]

The rubber composition relating to the present embodiment can be produced by a known method. For example, it can be produced by kneading each of the above-described components using a rubber kneading apparatus such as an open roll, a closed type kneader (Bunbury mixer, kneader, etc.), and the like.

The kneading step includes, for example, a base kneading step of kneading compounding agents and additives other than vulcanizing agents and vulcanization accelerators and a final kneading (F kneading) step of adding vulcanizing agents and vulcanization accelerators to the kneaded product obtained by the base kneading step and kneading them. Furthermore, the base kneading step can be divided into a plurality of steps, if desired.

A kneading condition is not particularly limited. Examples of kneading include, for example, in the base kneading step, a method of kneading at a discharge temperature of 150 to 170° C. for 3 to 10 minutes, and in the final kneading step, a method of kneading at 70 to 110° C. for 1 to 5 minutes. A vulcanization condition is not particularly limited. Examples of vulcanization include, for example, a method of vulcanizing at 150 to 200° C. for 10 to 30 minutes.

The tire of the present invention comprising the tread formed of the above-described rubber composition can be produced by a usual method. That is, the tire can be produced by extruding an unvulcanized rubber composition, in which each component as described above is compounded in the rubber component as necessary, into a shape of a first layer of a tread, attaching it together with an inner rubber layer of the tread and other tire members on a tire forming machine, and molding them by a usual method to form an unvulcanized tire, followed by heating and pressurizing this unvulcanized tire in a vulcanizing machine. A vulcanization condition is not particularly limited. Examples of vulcanization include, for example, a method of vulcanizing at 150 to 200° C. for 10 to 30 minutes.

### [Application of Tire]

The tire relating to the present embodiment can be appropriately used as a tire for a passenger car, a tire for a truck/bus, a motorcycle tire, or a racing tire. Among them, it is preferably used as a tire for a passenger car. Besides, the tire for a passenger car is a tire on the premise that it is mounted on a car running on four wheels and refers to one having a maximum load capacity of 1400 kg or less.

### EXAMPLES

Examples considered to be preferable in implementation (Examples) are shown below, though the scope of the present invention is not limited to Examples. Considering a tire having a first layer of a tread part obtained according to the compounding in Table 1 using various chemicals shown below, results, which are calculated based on the following evaluation methods, are shown in Table 1.

Various chemicals used in Examples and Comparative examples are collectively shown below.
NR: TSR20
SBR1: Nipol NS616 manufactured by ZS Elastomer Co., Ltd. (S-SBR, styrene content: 21% by mass, vinyl content: 61 mol %, Mw: 510,000, non-oil extended)
SBR2: SBR produced according to Production example 1 below (carboxylic acid-modified SBR, content of carboxylic acid group: 5% by mass, styrene content: 23% by mass, content of butadiene: 72% by mass)
BR1: Nipol BR1220 manufactured by Zeon Corporation (BR synthesized using a cobalt-based catalyst, cis content: 96 mol %, Mw: 460,000)
Carbon Black: Seast 6 manufactured by Tokai Carbon Co., Ltd. (N₂SA: 119 m²/g, average primary particle size: 22 nm)
Silica 1: Ultrasil (Registered Trademark) VN3 manufactured by Evonik Industries AG (N₂SA: 175 m²/g, average primary particle size: 17 nm)
Silica 2: Ultrasil (Registered Trademark) 9100GR manufactured by Evonik Industries AG (N₂SA: 235 m²/g, average primary particle size: 15 nm)
Silane coupling agent 1: Si266 manufactured by Evonik Industries AG (bis(3-triethoxysilylpropyl)disulfide)
Silane coupling agent 2 (lonically bonded modified silane coupling agent): KBE603 manufactured by Topco Technologies Corporation (N-2-(aminoethyl)-3-aminopropyltriethoxysilane)
Liquid polymer (lonically bonded modified liquid polymer): Kuraprene LIR410 manufactured by Kuraray Co., Ltd. (modified liquid polyisoprene having about 10 carboxyl groups per molecule and a number average molecular weight of 25,000)
Oil: Process X-140 manufactured by ENEOS Corporation
Resin component 1: SYLVATRAXX 4150 manufactured by Kraton Corporation (polyterpene resin, softening point: 115° C.)
Resin component 2: Gum rosin manufactured by Sigma-Aldrich
Metal salt: Potassium acetate
Zinc oxide: Zinc oxide No. 1 manufactured by Mitsui Mining & Smelting Co., Ltd.
Stearic acid: Bead stearic acid “CAMELLIA” manufactured by NOF CORPORATION
Wax: SUNNOC N manufactured by Ouchi Shinko Chemical Industry Co., Ltd. (paraffin wax)
Antioxidant: Nocrac 6C manufactured by Ouchi Shinko Chemical Industry Co., Ltd. (N-(1,3-dimethylbutyl)-N′-phenyl-p-phenylenediamine)
Sulfur: Powdered sulfur manufactured by Karuizawa Sulfur Co, Ltd.
Vulcanization accelerator 1: Nocceler D manufactured by Ouchi Shinko Chemical Industry Co., Ltd. (1,3-diphenylguanidine (DPG))
Vulcanization accelerator 2: Nocceler NS-G manufactured by Ouchi Shinko Chemical Industry Co., Ltd. (N-tert-butyl-2-benzothiazolylsulfenamide (TBBS))

### Production Example 1: Production of SBR2

Distilled water, an emulsifier (1), an emulsifier (2), an electrolyte, styrene, methacrylic acid, butadiene, and a molecular weight regulator are charged into a pressure reactor equipped with a stirrer, and an aqueous solution having a radical initiator and SFS dissolved therein and an aqueous solution having EDTA and a catalyst dissolved therein are added to the reactor to initiate polymerization. A polymerization terminator is then added to the reactor terminate the reaction, a latex is obtained, and an unreacted monomer is removed by steam distillation. A residue is added to alcohol and solidified while adjusting the pH to 3 to 5 with a saturated aqueous sodium chloride solution or formic acid to obtain a crumb-like polymer, which is then dried in a reduced pressure dryer to obtain SBR2.

Besides, materials used in Production example 1 are as follows.
Emulsifier (1): Rosin acid soap manufactured by Harima Chemicals Group, Inc.
Emulsifier (2): Fatty acid soap manufactured by FUJIFILM Wako Pure Chemical Corporation
Electrolytes: Sodium phosphate manufactured by FUJIFILM Wako Pure Chemical Corporation
Styrene: Styrene manufactured by FUJIFILM Wako Pure Chemical Corporation
Methacrylic acid: Methacrylic acid manufactured by FUJIFILM Wako Pure Chemical Corporation
Butadiene: 1,3-butadiene manufactured by Takachiho Trading Co., Ltd.
Molecular weight regulator: tert-dodecyl mercaptan manufactured by FUJIFILM Wako Pure Chemical Corporation
Radical initiator: Paramenthane hydroperoxide manufactured by NOF Corporation
SFS: Sodium formaldehyde sulfoxylate manufactured by FUJIFILM Wako Pure Chemical Corporation
EDTA: Sodium ethylenediaminetetraacetate manufactured by FUJIFILM Wako Pure Chemical Corporation
Catalyst: Ferric sulfate manufactured by FUJIFILM Wako Pure Chemical Corporation
Polymerization terminator: N,N′-dimethyldithiocarbamate manufactured by FUJIFILM Wako Pure Chemical Corporation
Alcohol: Methanol and Ethanol manufactured by KANTO CHEMICAL CO., INC.
Formic acid: Formic acid manufactured by KANTO CHEMICAL CO., INC.
Sodium chloride: Sodium chloride manufactured by FUJIFILM Wako Pure Chemical Corporation

### Examples and Comparative Examples

According to the compounding formulations shown in Table 1, using a 1.7 L closed Banbury mixer, all chemicals other than sulfur and vulcanization accelerators are kneaded until reaching a discharge temperature at 150° C. to 160° C. for 1 to 10 minutes to obtain a kneaded product. Next, using a twin-screw open roll, sulfur and vulcanization accelerators are added to the kneaded product, and the mixture is kneaded for 4 minutes until the temperature reaches 105° C. to obtain an unvulcanized rubber composition. The unvulcanized rubber composition is used to be extruded into a shape of a first layer of a tread part (thickness: 10 mm) with an extruder equipped with a mouthpiece having a predetermined shape and attached together with a second layer of the tread part (thickness: 4 mm) and other tire members to prepare an unvulcanized tire, and the unvulcanized tire is press-vulcanized under a condition at 170° C. for 12 minutes to obtain each test tire (size: 195/65R15, rim: 15×6JJ, internal pressure: 230 kPa) described in Table 1.

### <Viscoelasticity Measurement>

Each vulcanized rubber test piece, produced by being cut out with 20 mm in length×4 mm in width×1 mm in thickness from inside the first layer of the tread part of each test tire so that a tire circumferential direction becomes a long side and a tire radial direction becomes a thickness direction, is immersed in water at 25° C. for 12 hours to obtain a vulcanized rubber composition after being wet with water. For this vulcanized rubber composition after being wet with water, 30° C. E*_{W} and 30° C. tan δ_{W} are measured using a dynamic viscoelasticity measuring device (EPLEXOR series manufactured by gabo Systemtechnik GmbH) under a conditions of a temperature at 30° C., a frequency of 10 Hz, an initial strain of 5%, a dynamic strain of ±1%, and an extension mode. Next, the vulcanized rubber composition after being wet with water is dried under reduced pressure under a condition at 80° C. and with 1 kPa or less until it reaches a constant weight to obtain a vulcanized rubber composition after being dried. For this vulcanized rubber composition after being dried, 30° C. E*_{D} and 30° C. tan δ_{D} are measured using a dynamic viscoelasticity measuring device (EPLEXOR series manufactured by gabo Systemtechnik GmbH) under a conditions of a temperature at 30° C., a frequency of 10 Hz, an initial strain of 5%, a dynamic strain of +1%, and an extension mode.

### <Measurement of Glass Transition Temperature (Tg) of Rubber Composition>

For each rubber test piece produced by being cut out with 20 mm in length×4 mm in width×1 mm in thickness from a tread part of each test tire so that a tire circumferential direction becomes a long side and a tire radial direction becomes a thickness direction, a temperature distribution curve of tan δ is measured in a temperature range of −60° C. to −40° C., under a condition of a frequency of 10 Hz, an initial strain of 10%, a dynamic strain of ±0.5%, and a temperature rising rate of 2° C./min, using the dynamic viscoelasticity measuring device (EPLEXOR series manufactured by gabo Systemtechnik GmbH), and a temperature corresponding to the largest tan δ value in the obtained temperature distribution curve (tan δ peak temperature) is determined as a Tg of a rubber composition.

### <Measurement of Amount of Sulfur>

For each vulcanized rubber test piece, produced by being cut out with 20 mm in length×4 mm in width×1 mm in thickness from inside the first layer of the tread part of each test tire so that a tire circumferential direction becomes a long side and a tire radial direction becomes a thickness direction, an amount of sulfur, in % by mass, is measured by a oxygen combustion flask method in accordance with JIS K 6233:2016.

### <Wet Grip Performance>

Each test tire is mounted on all wheels of a vehicle (domestic FF2000 cc), and a braking distance from a point where a brake is applied at a speed of 100 km/h on a wet asphalt road surface is measured. An inverse value of a braking distance of each test tire is indicated as an index according to the following equation, with a braking distance of the control tire (Comparative example 1) being calculated as 100. The results show that the higher the index is, the more excellent the wet grip performance is.

(Wet grip performance index)=(braking distance of control tire)/(braking distance of each test tire)

### <Dry Grip Performance>

Each test tire is mounted on all wheels of a vehicle (domestic FF2000 cc), and a braking distance from a point where a brake is applied at a speed of 100 km/h on a dry asphalt road surface is measured. An inverse value of a braking distance of each test tire is indicated as an index according to the following equation, with a braking distance of the control tire (Comparative example 1) being calculated as 100. The results show that the higher the index is, the better the dry grip performance is.

(Dry grip performance index)=(braking distance of control tire)/(braking distance of each test tire)

### <Fuel Efficiency>

Using a rolling resistance tester, a rolling resistance when each test tire is made to run with a rim of 15×6JJ, an internal pressure of 230 kPa, a load of 3.43 kN, and a speed at 80 km/h is measured, and an inverse value thereof is indicated as an index with Comparative example 2 being as 100. The results show that the larger the index is, the smaller the rolling resistance is and the better the fuel efficiency is.

### <Overall Performance>

A sum of a wet grip performance index, a dry grip performance index, and a fuel efficiency index is indicated as an overall performance index.

TABLE 1

| Example | | | | Comparative example | | |
|---|---|---|---|---|---|---|
| 1 | 2 | 3 | 4 | 1 | 2 | 3 |

Compounding amount (part by mass)

| | | | | | | | |
|---|---|---|---|---|---|---|---|
| NR | 10 | 10 | 10 | 10 | 10 | 10 | 10 |
| SBR1 | 75 | — | 75 | — | 75 | 75 | 75 |
| SBR2 | — | 75 | — | 75 | — | — | — |
| BR | 15 | 15 | 15 | 15 | 15 | 15 | 15 |
| Carbon black | 10 | 10 | 10 | 10 | 10 | 10 | 10 |
| Silica 1 | 70 | 70 | 70 | 70 | 70 | 70 | 70 |
| Silica 2 | 10 | 10 | 10 | 10 | 10 | 10 | 10 |
| Silane coupling agent 1 | — | — | 10 | 10 | 10 | — | — |
| Silane coupling agent 2 | 10 | 10 | — | — | — | 10 | 10 |
| Liquid polymer | 15 | — | — | — | — | 15 | 15 |
| Oil | — | 15 | 15 | 15 | 15 | — | — |
| Resin component 1 | 15 | 15 | — | 15 | 15 | 15 | 15 |
| Resin component 2 | — | — | 15 | — | — | — | — |
| Metal salt | 5 | 5 | 5 | 5 | — | 5 | 5 |
| Zinc oxide | 2.0 | 2.0 | 2.0 | 2.0 | 2.0 | 2.0 | 2.0 |
| Stearic acid | 2.0 | 2.0 | 2.0 | 2.0 | 2.0 | 2.0 | 2.0 |
| Wax | 2.0 | 2.0 | 2.0 | 2.0 | 2.0 | 2.0 | 2.0 |
| Antioxidant | 2.0 | 2.0 | 2.0 | 2.0 | 2.0 | 2.0 | 2.0 |
| Sulfur | 1.5 | 1.5 | 1.5 | 1.5 | 1.5 | 1.5 | 1.5 |
| Vulcanization accelerator 1 | 2.0 | 2.0 | 2.0 | 2.0 | 2.0 | 2.0 | 2.0 |
| Vulcanization accelerator 2 | 2.0 | 2.0 | 2.0 | 2.0 | 2.0 | 2.0 | 2.0 |

Physical property

| | | | | | | | |
|---|---|---|---|---|---|---|---|
| 30° C. E*_{D} (MPa) | 7.3 | 7.1 | 6.5 | 6.8 | 7.0 | 7.3 | 7.3 |
| 30° C. E*_{W} (MPa) | 5.9 | 5.6 | 5.2 | 5.4 | 6.2 | 5.9 | 5.9 |
| \|30° C. E*_{D} − 30° C. E*_{W}\| | 1.4 | 1.5 | 1.3 | 1.4 | 0.8 | 1.4 | 1.4 |
| 30° C. tan δ_{D} | 0.30 | 0.31 | 0.29 | 0.28 | 0.30 | 0.30 | 0.30 |
| 30° C. tan δ_{W} | 0.34 | 0.36 | 0.32 | 0.32 | 0.29 | 0.34 | 0.34 |
| \|30° C. tan δ_{D} − 30° C. tan δ_{W}\| | 0.04 | 0.05 | 0.03 | 0.04 | 0.01 | 0.04 | 0.04 |
| Amount of sulfur (% by mass) | 0.64 | 0.64 | 0.64 | 0.64 | 0.64 | 0.64 | 0.64 |
| Tg of rubber composition (° C.) | −37 | −39 | −39 | −36 | −41 | −37 | −37 |

Tire

| | | | | | | | |
|---|---|---|---|---|---|---|---|
| Land ratio R | 0.60 | 0.60 | 0.60 | 0.60 | 0.60 | 0.40 | 0.70 |
| Maximum load capacity W_{L} (kg) | 514 | 514 | 514 | 514 | 514 | 514 | 514 |
| Tire weight G (kg) | 10.28 | 10.28 | 10.28 | 10.28 | 10.28 | 9.26 | 15.42 |
| G/W_{L} | 0.020 | 0.020 | 0.020 | 0.020 | 0.020 | 0.018 | 0.030 |
| \|30° C. E*_{D} − 30° C. E*_{W}\| × R | 0.84 | 0.90 | 0.78 | 0.84 | 0.48 | 0.56 | 0.98 |
| \|30° C. tan δ_{D} − 30° C. tan δ_{W}\|/(G/W_{L}) | 2.0 | 2.5 | 1.5 | 2.0 | 0.5 | 2.2 | 1.3 |
| Wet grip performance | 105 | 108 | 104 | 105 | 100 | 95 | 98 |
| Dry grip performance | 101 | 102 | 101 | 101 | 100 | 93 | 104 |
| Fuel efficiency | 101 | 102 | 100 | 101 | 100 | 105 | 93 |
| Overall performance | 307 | 312 | 305 | 307 | 300 | 293 | 295 |

### Embodiments

Examples of embodiments of the present invention will be shown below.

[1] A tire comprising a tread part having at least one rubber layer, wherein a first layer constituting a tread surface is composed of a rubber composition comprising a rubber component and a filler, wherein the rubber composition comprises 45 parts by mass or more of the filler based on 100 parts by mass of the rubber component, wherein, in a case where W_{L}, in kg, represents a maximum load capacity of the tire, G, in kg, represents a weight of the tire, R represents a land ratio of the tread part on a ground-contacting surface, 30° C. E*_{D} (MPa) represents a complex elastic modulus of the rubber composition at 30° C. when drying, 30° C. E*_{W} (MPa) represents a complex elastic modulus of the rubber composition at 30° C. when wetting, 30° C. tan δ_{D} represents a tan δ at 30° C. of the rubber composition when drying, and 30° C. tan δ_{W} represents a tan δ at 30° C. of the rubber composition when wetting, W_{L}, G, R, 30° C. E*_{D}, 30° C. E*_{W}, 30° C. tan δ_{D}, and 30° C. tan δ_{W} satisfy the following inequalities (1) to (6).

$$R \geq 0.5 \qquad ( 1 )$$

$$G / {W}_{L} \leq 0.025 \qquad ( 2 )$$

$$\vert 30 ° C . {E}_{D}^{⋆} - 30 ° C . {E}^{⋆} w \vert \geq 1.3 \qquad ( 3 )$$

$$\vert 30 ° C . tan {δ}_{D} - 30 ° C . tan δ w \vert \geq 0.03 \qquad ( 4 )$$

$$\vert 30 ° C . {E}_{D}^{⋆} - 30 ° C . {E}^{⋆} w \vert \times R \geq 0.7 \qquad ( 5 )$$

$$\vert 30 ° C . tan {δ}_{D} - 30 ° C . tan δ w \vert / ( G / {W}_{L} ) \geq 1.3 \qquad ( 6 )$$

[2] The tire of [1] above, wherein the rubber composition comprises 40 parts by mass or more of silica based on 100 parts by mass of the rubber component.

[3] The tire of [2] above, wherein an average primary particle size of the silica is 20 nm or less.

[4] The tire of any one of [1] to [3] above, wherein the rubber composition comprises 5 parts by mass or more of a plasticizer based on 100 parts by mass of the rubber component.

[5] The tire of [4] above, wherein the plasticizer comprises at least one selected from the group consisting of a resin component and a liquid polymer.

[6] The tire of any one of [1] to [5] above, wherein the rubber component comprises 10% by mass or more of a butadiene rubber.

[7] The tire of any one of [1] to [6] above, wherein an amount of sulfur in the rubber composition is 0.1% by mass or more.

[8] The tire of any one of [1] to [7] above, wherein a glass transition temperature of the rubber composition is −10° C. or higher.

[9] The tire of any one of [1] to [8] above, wherein 30° C. E*_{D} is 3.0 MPa or more.

[10] The tire of any one of [1] to [9] above, wherein 30° C. tan δ_{D} is 0.10 or more.

What is claimed is:

1. A tire comprising a tread part having at least one rubber layer,
wherein a first layer constituting a tread surface is composed of a rubber composition comprising a rubber component and a filler,
wherein the rubber composition comprises 45 parts by mass or more of the filler based on 100 parts by mass of the rubber component,
wherein, in a case where W_{L}, in kg, represents a maximum load capacity of the tire, G, in kg, represents a weight of the tire, R represents a land ratio of the tread part on a ground-contacting surface, 30° C. E*_{D} (MPa) represents a complex elastic modulus of the rubber composition at 30° C. when drying, 30° C. E*_{W} (MPa) represents a complex elastic modulus of the rubber composition at 30° C. when wetting, 30° C. tan δ_{D} represents a tan δ at 30° C. of the rubber composition when drying, and 30° C. tan δ_{W} represents a tan δ at 30° C. of the rubber composition when wetting, W_{L}, G, R, 30° C. E*_{D}, 30° C. E*_{W}, 30° C. tan δ_{D}, and 30° C. tan δ_{W} satisfy the following inequalities (1) to (6).
$$R \geq 0.5 \qquad ( 1 )$$
$$G / {W}_{L} \leq 0.025 \qquad ( 2 )$$
$$\vert 30 ° C . {E}_{D}^{⋆} - 30 ° C . {E}^{⋆} w \vert \geq 1.3 \qquad ( 3 )$$
$$\vert 30 ° C . tan {δ}_{D} - 30 ° C . tan δ w \vert \geq 0.03 \qquad ( 4 )$$
$$\vert 30 ° C . {E}_{D}^{⋆} - 30 ° C . {E}^{⋆} w \vert \times R \geq 0.7 \qquad ( 5 )$$
$$\vert 30 ° C . tan {δ}_{D} - 30 ° C . tan δ w \vert / ( G / {W}_{L} ) \geq 1.3 \qquad ( 6 )$$

2. The tire of claim 1, wherein the rubber composition comprises 40 parts by mass or more of silica based on 100 parts by mass of the rubber component.

3. The tire of claim 2, wherein an average primary particle size of the silica is 20 nm or less.

4. The tire of claim 1, wherein the rubber composition comprises 5 parts by mass or more of a plasticizer based on 100 parts by mass of the rubber component.

5. The tire of claim 4, wherein the plasticizer comprises at least one selected from the group consisting of a resin component and a liquid polymer.

6. The tire of claim 1, wherein the rubber component comprises 10% by mass or more of a butadiene rubber.

7. The tire of claim 1, wherein an amount of sulfur in the rubber composition is 0.1% by mass or more.

8. The tire of claim 1, wherein a glass transition temperature of the rubber composition is −10° C. or higher.

9. The tire of claim 1, wherein 30° C. E*_{D} is 3.0 MPa or more.

10. The tire of claim 1, wherein 30° C. tan δ_{D} is 0.10 or more.
